(19) United States
(12) Patent Application Publication
(10) Pub. No.: US 2026/0367049 A1
(43) Pub. Date: Nov. 19, 2026

(54) METHODS FOR MEASURING LEVELS OF POLYSORBATE(S)

(71) Applicant: Eli Lilly and Company, Indianapolis, IN (US)

(72) Inventors: Shou Song Zhang, Indianapolis, IN (US); Jeffrie Allen Evans, Indianapolis, IN (US); Becky Sue Lee, Indianapolis, IN (US)

(21) Appl. No.: 19/144,190

(22) PCT Filed: Dec. 22, 2023
(86) PCT No.: PCT/US2023/085809

§ 371 Date: Jun. 27, 2025

Related U.S. Application Data
(60) Provisional application No. 63/477,904, filed on Dec. 30, 2022.

(51) Int. Cl. G01N 30/34; G01N 30/02; G01N 30/04; G01N 30/62; G01N 30/74; G01N 30/86; G01N 30/88

(52) U.S. Cl. CPC G01N 30/34; G01N 30/74; G01N 30/8641; G01N 30/88; G01N 2030/027; G01N 2030/047; G01N 2030/626; G01N 2030/884

(57) ABSTRACT

The disclosure provides methods for measuring polysorbate levels in a sample. The method comprises applying an aliquot of the sample onto a high-performance liquid chromatography system with a mixed-mode column, eluting the sample with a gradient from a first mobile phase to a second mobile phase, and applying evaporative light-scattering detection to the eluant as it exits the column, thereby measuring polysorbate levels. The first mobile phase comprises 0-20% of an acid, 1-70% acetonitrile, methanol, tetrahydrofuran, tetrahydrofuran, isopropyl alcohol, or mixtures thereof, and water. The second mobile phase comprises 0-20% of an acid, 80-100% acetonitrile, methanol, tetrahydrofuran, tetrahydrofuran, isopropyl alcohol, or mixtures thereof, and optionally water.

### RELATED APPLICATIONS

This application claims priority to U.S. Provisional Patent Application No. 63/477,904, filed Dec. 30, 2022, the entire content of which is incorporated herein by reference.

### DISCLOSURE

The disclosure relates to methods for measuring levels of polysorbate(s) in a sample. In some embodiments, the method provides for quantification of the level of polysorbate in the sample.

Polysorbate is used as a surfactant used in pharmaceutical formulations, in particular drug substances and drug products. Polysorbate is used as a surfactant to stabilize biopharmaceutical products. Polysorbate is commonly used to stabilize proteins, in particular antibodies.

Polysorbates are a class of molecules comprising multiple structures, including but not limited to, polysorbate 20, polysorbate 40, polysorbate 60, and polysorbate 80. Measuring the level of polysorbate may comprise measuring the level of one or more polysorbate structure.

Degradation of polysorbate is a known problem. Polysorbate may degrade by hydrolysis or oxidation. Degradation of polysorbate reduces the amount of polysorbate in the sample, thus reducing the ability to stabilize other components, such as therapeutic proteins, in the sample. Therefore, a need exists to measure the amount of polysorbate in a sample. In particular, measuring the level of polysorbate in drug substances and drug products is important to identify polysorbate degradation that may lead to instability in other molecules in the formulation.

Conventional techniques for measuring component ingredients in a sample do not directly or accurately measure polysorbate levels. Polysorbate molecules lack chemical structures such as strong chromophores so previous attempts to detect polysorbate directly by UV-Vis or fluorescence have not been successful.

Existing methods of measuring polysorbate levels are destructive and/or indirect. One known method for measuring polysorbate focuses on identifying polysorbate subspecies, using ultra-high performance liquid chromatography coupled with high-resolution mass spectrometry. Another known method digests the polysorbate molecules then characterizes the degradants, typically by liquid chromatography coupled to mass spectrometry, followed by liquid chromatography coupled to charged aerosol detection and liquid chromatography coupled to evaporative light scattering detection. In some embodiments, the characterized degradant is free fatty acids. Therefore, most known methods for measuring polysorbate levels in samples are indirect and require destruction of polysorbate to characterize the resulting degradants or subspecies.

Moreover, prior methods identified higher than expected polysorbate levels in samples during robustness studies, including overestimations of 30% compared to expected results. Prior attempts to identify gradient programs did not resolve this issue.

Previous attempts to generate robust, simple, and cost-effective methods for accurately measuring levels of specific polysorbates have been unsuccessful. One previous attempt required solid-phase extraction to remove protein prior to further separation steps for accurate measurements, which is inefficient, time-consuming, and labor-intensive.

A need exists for an improved method for directly and accurately measuring polysorbate levels in a sample.

The present disclosure satisfies this need by providing a robust, simple, cost-effective method for directly and accurately measuring polysorbate levels.

### SUMMARY

The disclosure is directed to methods for measuring levels of polysorbate(s) in a sample. The methods of the disclosure directly and accurately measure polysorbate levels in a sample in a robust, simple, and cost-effective manner.

In some embodiments, the disclosure is directed to a method for measuring polysorbate levels in a sample. In some embodiments, the method comprises applying an aliquot of the sample onto a high-performance liquid chromatography system with a mixed-mode column, eluting the sample with a gradient from a first mobile phase to a second mobile phase, and applying evaporative light-scattering detection to the eluant after exiting the column, thereby measuring polysorbate levels. In some embodiments, the first mobile phase comprises 0-20% of an acid, 1-70% of an organic solvent selected from of an organic solvent selected from acetonitrile, methanol, tetrahydrofuran, isopropyl alcohol, or mixtures thereof, and water. In some embodiments, the second mobile phase comprises 0-20% of an acid, 80-100% of an organic solvent selected from acetonitrile, methanol, tetrahydrofuran, isopropyl alcohol, or mixtures thereof, and optionally water.

In some embodiments, the acid is a volatile acid.

In some embodiments, the volatile acid is formic acid.

In some embodiments, the first mobile phase and/or the second mobile phase comprises 0-2% acid.

In some embodiments, the organic solvent in the first mobile phase is different from the organic solvent in the second mobile phase.

In some embodiments, the first mobile phase comprises 2% formic acid, 20% acetonitrile, and 78% purified water.

In some embodiments, the second mobile phase comprises 2% formic acid and 98% isopropyl alcohol.

In some embodiments, the measured polysorbate comprises polysorbate 20, polysorbate 40, polysorbate 60 and/or polysorbate 80.

In some embodiments, the measured polysorbate comprises polysorbate 20 and/or polysorbate 80.

In some embodiments, the measured polysorbate comprises polysorbate 20.

In some embodiments, the measured polysorbate comprises polysorbate 80.

In some embodiments, before applying the aliquot to be measured to the column, the method further comprises applying a blank onto a high-performance liquid chromatography system with a mixed-mode column, eluting the blank with a gradient from a first mobile phase to a second mobile phase and applying evaporative light-scattering detection to the blank after it exits the column. In some embodiments, the first mobile phase comprises 0-20% of an acid, 1-70% of an organic solvent selected from acetonitrile, methanol, tetrahydrofuran, isopropyl alcohol, or mixtures thereof, and water. In some embodiments, the second mobile phase comprises 0-20% of an acid, 80-100% of an organic solvent selected from acetonitrile, methanol, tetrahydrofuran, isopropyl alcohol, or mixtures thereof, and optionally water.

In some embodiments, applying evaporative light-scattering detection to the blank produces a baseline signal.

In some embodiments, after the first blank has been applied to the column and before applying the aliquot to be measured to the column, the method further comprises applying a second blank onto a high performance liquid chromatography system with a mixed-mode column, eluting the blank with a gradient from a first mobile phase to a second mobile phase, and applying evaporative light-scattering detection to the blank after it exits the column, wherein applying evaporative light-scattering detection to the second blank sample produces a stable baseline signal. In some embodiments, the first mobile phase comprises 0-20% of an acid, of an organic solvent selected from 1-70% acetonitrile, methanol, tetrahydrofuran, isopropyl alcohol, or mixtures thereof, and water. In some embodiments, the second mobile phase comprises 0-20% of an acid, of an organic solvent selected from 80-100% of an organic solvent selected from acetonitrile, methanol, tetrahydrofuran, isopropyl alcohol, or mixtures thereof, and optionally water.

In some embodiments, the first mobile phase and/or the second mobile phase was prepared within 2 weeks of performing the method.

In some embodiments, the method further comprises quantifying the measured level of polysorbate in the sample.

In some embodiments, quantifying the measured level of polysorbate in the sample comprises comparing the measured amount of polysorbate against a calibration curve.

In some embodiments, comparing the measured amount of polysorbate against the calibration curve identifies a quantity of polysorbate in the aliquot.

In some embodiments, the calibration curve is generated by separately applying one or more concentration standards comprising known amounts of polysorbate onto a high performance liquid chromatography system with a mixed-mode column, eluting the concentration standards with a gradient from a first mobile phase to a second mobile phase, applying evaporative light-scattering detection to the concentration standards after each exits the column, thereby measuring polysorbate levels, and generating a calibration curve from the measured levels of polysorbate in the concentration standards. In some embodiments, the first mobile phase comprises 0-20% of an acid, 1-70% of an organic solvent selected from acetonitrile, methanol, tetrahydrofuran, isopropyl alcohol, or mixtures thereof, and water. In some embodiments, the second mobile phase comprises 0-20% of an acid, 80-100% of an organic solvent selected from acetonitrile, methanol, tetrahydrofuran, isopropyl alcohol, or mixtures thereof, and optionally water.

In some embodiments, one or more of the concentration standards produces a larger signal than the aliquot and one or more of the concentration standards produces a smaller signal than the aliquot.

In some embodiments, the amount of polysorbate in the one or more concentration standards does not exceed the maximum detectable signal for evaporative light-scattering detection.

In some embodiments, the amount of polysorbate in the concentration standard comprising the largest amount of polysorbate has a peak height of about 80% of the maximum detectable signal.

In some embodiments, applying evaporative light-scattering detection to a blank produces a signal that is lower than a signal produced by the concentration standard comprising the smallest amount of polysorbate.

As used herein, a “blank” does not contain polysorbate. In some embodiments, the blank is water.

In some embodiments, the calibration curve is generated using three or more, four or more, five or more, or six or more concentration standards.

In some embodiments, the calibration curve is prepared gravimetrically.

In some embodiments, the calibration curve has a coefficient of determination (R²) greater than or equal to 0.995.

In some embodiments, the coefficient of determination (R²) is greater than or equal to 0.998.

In some embodiments, the calibration curve is prepared using a quadratic fit through zero.

In some embodiments, the percentage relative standard deviation of two or more aliquots of the sample is 10 or less.

In some embodiments, the gradient comprises 100% first mobile phase and 0% second mobile phase from 0.0 minutes to 2.0 minutes, and/or 85% first mobile phase and 15% second mobile phase from 2.1 minutes to 5.0 minutes, and/or 30% first mobile phase and 70% second mobile phase from 5.1 minutes to 7.6 minutes, and/or 0% first mobile phase and 100% second mobile phase from 7.7 minutes to 9.0 minutes, and/or 100% first mobile phase and 0% second mobile phase from 9.1 minutes to 10.0 minutes.

In some embodiments, the sample is applied onto the mixed-mode column at a temperature of 22-28 °C.

In some embodiments, the eluant is eluted from the column with a flow rate of 0.9-1.1 mL/min.

In some embodiments, the evaporative light-scattering detection utilizes an Alltech 3300 detector.

In some embodiments wherein the method utilizes an Alltech 3300 detector, the method is performed using a nebulizer temperature of the detector of 68-72 °C.

In some embodiments wherein the method utilizes an Alltech 3300 detector, the method is performed using a gas flow rate of the detector of 2.3-2.7 L/min.

In some embodiments, the evaporative light-scattering detection utilizes an Agilent 1260 evaporative light-scattering detector.

In some embodiments wherein the method utilizes an Agilent 1260 evaporative light-scattering detector, the method is performed using a nebulizer temperature of the detector of 43-47 °C.

In some embodiments wherein the method utilizes an Agilent 1260 evaporative light-scattering detector, method is performed using a heating tube temperature of the detector of 70-90 °C.

In some embodiments wherein the method utilizes an Agilent 1260 evaporative light-scattering detector, the method is performed using a gas flow of the detector of 1.3-1.7 L/min.

In some embodiments, the sample is a drug substance.

In some embodiments, the sample is a drug product.

In some embodiments, the method comprises: applying a first polysorbate concentration standard onto a high performance liquid chromatography system with a mixed-mode column, eluting the sample with a gradient from a first mobile phase to a second mobile phase, and applying evaporative light-scattering detection to the eluant after it exits the column, thereby measuring polysorbate levels; applying one or more further polysorbate concentration standards comprising different known amounts of polysorbate compared to the first concentration standard onto a high performance liquid chromatography system with a mixed-mode column, eluting the sample with a gradient from a first mobile phase to a second mobile phase, and applying evaporative light-scattering detection to the eluant after it exits the column, thereby measuring polysorbate levels; generating a calibration curve from the measured polysorbate levels in the polysorbate concentration standards; applying an aliquot of the sample onto a high performance liquid chromatography system with a mixed-mode column, eluting the sample with a gradient from a first mobile phase to a second mobile phase; applying evaporative light-scattering detection to the eluant after it exits the column, thereby measuring polysorbate levels; and quantifying the amount of polysorbate in the aliquot of the sample by comparison against the calibration curve. In some embodiments, the first mobile phase comprises 2% formic acid, 20% acetonitrile, and 78% purified water and the second mobile phase comprises 2% formic acid, and 98% isopropyl alcohol.

In some embodiments, the method is practiced according to any of the features disclosed.

### BRIEF DESCRIPTION OF DRAWING(S)

The drawings are for illustration purposes only and do not provide any limitation on the disclosure.

FIG. 1 illustrates an exemplary water blank chromatogram.

FIG. 2 illustrates an exemplary chromatogram of a local reference standard.

FIG. 3 illustrates an exemplary chromatogram for a concentration standard.

FIG. 4a and FIG. 4b illustrate exemplary polysorbate 80 chromatograms. FIG. 4a provides an exemplary chromatogram from a drug substance sample. FIG. 4b provides an exemplary chromatogram from a drug product sample.

FIG. 5a and FIG. 5b illustrate JMP statistical output for S2. FIG. 5a depicts S2 distributions. FIG. 5b depicts variability charts for S2. FIG. 5c depicts response results for S2.

FIG. 6a, FIG. 6b, and FIG. 6c illustrate JMP statistical output for S3. FIG. 6a depicts S3 distributions. FIG. 6b depicts variability charts for S3. FIG. 6c depicts response results for S3.

FIG. 7a, FIG. 7b, and FIG. 7c illustrate JMP statistical output for D1. FIG. 7a depicts D1 distributions. FIG. 7b depicts variability charts for D1. FIG. 7c depicts response results for D1.

FIG. 8 illustrates eluant peaks for multiple samples comprising polysorbate 80 and a Check standard.

### DETAILED DESCRIPTION

The disclosure is directed to methods for measuring levels of polysorbate(s) in a sample.

The methods of the disclosure accurately measure polysorbate levels in a sample in a robust, simple, and cost-effective manner.

In some embodiments, the method of the disclosure is non-destructive.

In some embodiments, the method of the disclosure directly measures polysorbate levels.

### High Performance Liquid Chromatography

The disclosure is directed to a method for measuring polysorbate levels in a sample. In some embodiments, an aliquot of the sample is applied onto a high-performance liquid chromatography (HPLC) system with a mixed-mode column.

In some embodiments, the aliquot has a volume of 10 μL.

High performance liquid chromatography is a known technique for the separation of components within an aliquot applied to the column. In some embodiments, the method of the disclosure utilizes a mixed-mode column. Mixed-mode columns are known in the art. In some embodiments, the method of the disclosure utilizes a reversed-phase column. Reversed-phase columns are known in the art. Typically, a reversed-phase column comprises a non-polar stationary phase.

In some embodiments, the high-performance liquid chromatography system is an Agilent 1200/1260 system. In some embodiments, the high-performance liquid chromatography system is an Agilent 1260 Infinity II. The skilled person would appreciate that other high performance liquid chromatography systems could readily be utilized with the method of the disclosure, and that these systems are purely exemplary.

In some embodiments, the sample is applied onto the mixed-mode column at a temperature of 22-28 °C.

In some embodiments, the method of the disclosure elutes components of the aliquot from the mixed-mode column with a gradient from a first mobile phase to a second mobile phase.

The disclosure provides mobile phases resulting in a robust, simple, and cost-effective method of measuring polysorbate levels.

In some embodiments, the first mobile phase comprises 0-20% of an acid, 1-70% of organic solvent, and water.

In some embodiments, the first mobile phase comprises 0-20% of an acid, 1-70% of an organic solvent selected from acetonitrile, methanol, tetrahydrofuran, isopropyl alcohol, or mixtures thereof, and water.

In some embodiments, the acid is a volatile acid. In some embodiments, the volatile acid is formic acid.

Polysorbate and other components of an aliquot may bind to the column, which can create a carry-over issue. In some embodiments, carry over can occur when components of a previous sample, blank, or concentration standard applied to the column bind to the column and interfere or co-elute with a subsequent sample, blank, or concentration standard applied to the column. In some embodiments, the presence of an acid, optionally an organic acid, in the first mobile phase and/or the second mobile phase resolves the carry over issue. In some embodiments, this results in a chromatogram with good/improved tailing.

In some embodiments, the first mobile phase comprises 0-2% acid.

In some embodiments, the first mobile phase comprises 2% formic acid, 20% acetonitrile, and 78% purified water.

In some embodiments, the second mobile phase comprises 0-20% of an acid, 80-100% of organic solvent, and optionally water.

In some embodiments, the second mobile phase comprises 0-20% of an acid, 80-100% of an organic solvent selected from acetonitrile, methanol, tetrahydrofuran, isopropyl alcohol, or mixtures thereof, and optionally water.

In some embodiments, the acid is a volatile acid. In some embodiments, the volatile acid is formic acid.

In some embodiments, the second mobile phase comprises 0-2% acid.

In some embodiments, the second mobile phase comprises 2% formic acid and 98% isopropyl alcohol.

In some embodiments, the first mobile phase comprises 2% formic acid, 20% acetonitrile, and 78% purified water and the second mobile phase comprises 2% formic acid and 98% isopropyl alcohol.

In some embodiments, a different organic solvent is added to the first mobile phase compared to the second mobile phase. In some embodiments, the organic solvents are selected from acetonitrile, methanol, tetrahydrofuran, isopropyl alcohol, or mixtures thereof. In some embodiments, the selection of two different organic solvents elutes more protein and/or matrix components compared to embodiments in which the same organic solvent is selected for the first mobile phase and the second mobile phase, thereby providing additional resolution strength.

As used herein, “matrix” refers to the solvent system or formulation system containing an active pharmaceutical ingredient, such as an antibody.

In some embodiments, wherein a different organic solvent is provided in the first mobile phase compared to the second mobile phase, the method yields more accurate results according to the acceptance criteria in Table 3, thereby improving the robustness of the method.

In some embodiments, the second mobile phase comprises methanol, tetrahydrofuran, isopropyl alcohol, or mixtures thereof. In some embodiments said second mobile phase does not comprise acetonitrile. In some embodiments, the second mobile phase produces more efficient elution, resulting in more define peaks, thereby improving tailing and interference.

In some embodiments, the first mobile phase and/or the second mobile phase was prepared within 2 weeks of performing the method.

In some embodiments, preparing the first mobile phase and/or the second mobile phase within 2 weeks of performing the method improves the robustness and/or the accuracy of the method.

In some embodiments, the gradient used to elute the polysorbate is 100% first mobile phase and 0% second mobile phase from 0.0 minutes to 2.0 minutes, and/or 85% first mobile phase and 15% second mobile phase from 2.1 minutes to 5.0 minutes, and/or 30% first mobile phase and 70% second mobile phase from 5.1 minutes to 7.6 minutes, and/or 0% first mobile phase and 100% second mobile phase from 7.7 minutes to 9.0 minutes, and/or 100% first mobile phase and 0% second mobile phase from 9.1 minutes to 10.0 minutes.

In some embodiments, the eluant is eluted from the column with a flow rate of 0.9-1.1 mL/min.

In some embodiments, the aliquot may comprise other components in addition to polysorbate, including, but not limited to, proteins, polypeptides, peptides, polysorbate subspecies, and/or polysorbate degradants. Typically, the gradient elutes polysorbate at a different point compared to other components of the aliquot.

Polysorbate subspecies are polysorbate-related molecules or structural variants. Exemplary subspecies include polyoxyethylene (20) sorbitan monolaureate, polyoxyethylene (20) sorbitan monooleate, and polyoxyethylene (19) isosorbitan monolaureate.

Polysorbate degradants are structurally altered polysorbate-related components. Exemplary degradants include free fatty acids, oxidized polysorbate species, aldehydes, and short chain ketones. In some circumstances, polysorbate degradation also increases the amounts of polysorbate subspecies.

In some embodiments, the aliquot comprises more than one polysorbate. In some embodiments, the gradient elutes different polysorbates at different time points.

### Evaporative Light-Scattering Detection

In some embodiments, evaporative light-scattering detection (ELSD) is applied to the eluant. Evaporative light-scattering detection is a technique known in the art. Briefly, eluant passes through a heated chamber to evaporate the mobile phase solvent. Non-volatile components of the aliquot form solid particulates upon solvent evaporation. Solid particulates scatter UV radiation, resulting in a detectable signal.

Evaporative light-scattering detection can detect non-UV-absorbing components in an aliquot. In some embodiments, the method of the disclosure applies evaporative light-scattering detection to detect polysorbate.

Traditionally, evaporative light-scattering detection is applied to detect the presence or absence of components. The disclosure provides a method for measuring the levels of polysorbate(s) by evaporative light-scattering detection.

In some embodiments, evaporative light-scattering detection identifies one or more signals, corresponding to one or more components in the eluant. In some embodiments, the one or more signals correspond to the output from evaporative light-scattering detection.

In some embodiments, the method produces a signal for polysorbate, from which the amount of polysorbate is measured.

In some embodiments, wherein the aliquot comprises more than one polysorbate structure, the method produces a signal for each different polysorbate structure, from which the amount of each different polysorbate is measured.

In some embodiments, a gain is applied during evaporative light-scattering detection.

In some embodiments, evaporative light-scattering detection utilizes an Alltech 3300 evaporative light-scattering detector. In some embodiments, when an Alltech 3300 detector is used, the method is performed using a nebulizer temperature of the detector of 68-72 °C. In some embodiments, when an Alltech 3300 detector is used, the method is performed using a gas flow rate of the detector of 2.3-2.7 L/min. In some embodiments, when an Alltech 3300 detector is used, the method produces a tailing result of 1.16 to 1.46.

In some embodiments, evaporative light-scattering detection utilizes an Agilent 1260 evaporative light-scattering detector. In some embodiments, when an Agilent 1260 evaporative light-scattering detector is used, the method is performed using a nebulizer temperature of the detector of 43-47 °C. In some embodiments, when an Agilent 1260 detector is used, the method is performed using a heating tube temperature of the detector of 70-90 °C. In some embodiments, when an Agilent 1260 evaporative light-scattering detector is used, the method is performed using a gas flow of the detector of 1.3-1.7 L/min.

### Samples

The sample in which polysorbate levels are to be measured may be any sample. Typically, the sample comprises, or is expected to comprise, polysorbate.

In some embodiments, the sample comprises one or more polysorbate. In some embodiments, the one or more polysorbate may be polysorbate 20, polysorbate 40, polysorbate 60, polysorbate 80, or mixtures thereof.

In some embodiments, sample comprises polysorbate 80.

In some embodiments, the sample comprises polysorbate 20.

In some embodiments, the sample is a drug substance. The term “drug substance” refers to a composition comprising an active ingredient or active pharmaceutical ingredient. In some embodiments, the drug substance is intended to furnish pharmacological activity or other direct effect in the diagnosis, cure mitigation, treatment, or prevention of disease, or to affect the structure or any function of the human body. In some embodiments, the drug substance does not comprise intermediates from synthesis. In some embodiments, the drug substance does not comprise excipients or other ingredients necessary for the final formulation. In some embodiments, the drug substance comprises one or more components in addition to the active ingredient or active pharmaceutical ingredient. In some embodiments, the additional component is one or more polysorbate.

In some embodiments, the drug substance comprises a therapeutic protein or peptide. Optionally, the therapeutic protein is an antibody.

In some embodiments, the sample is a drug product. The term “drug product” refers to the finished dosage form containing the drug substance. In some embodiments, the drug product is the final formulation for admission to a patient. In some embodiments, the drug product comprises the drug substance in association with one or more further ingredients. In some embodiments, the one or more further ingredients comprises one or more excipients. In some embodiments, the one or more further ingredients are not polysorbate.

The term “polysorbate” is used to define one or more polysorbates. Polysorbates include, but are not limited to, polysorbate 20, polysorbate 40, polysorbate 60, and polysorbate 80.

In some embodiments, the method measures the level of one polysorbate in a sample. In some embodiments, the polysorbate is polysorbate 20, polysorbate 40, polysorbate 60, or polysorbate 80. In some embodiments, the polysorbate is polysorbate 80. In some embodiments, the polysorbate is polysorbate 20.

In some embodiments, the method measures the levels of two polysorbates in a sample. In some embodiments, the method measures the levels of two or more polysorbates in a sample. In some embodiments, the two or more polysorbates are selected from polysorbate 20, polysorbate 40, polysorbate 60 and polysorbate 80.

In some embodiments, the method measures polysorbate 80 levels and polysorbate 20 levels.

### Blanks

In some embodiments, before applying the aliquot to be measured to the column, the method comprises applying one or more blanks to the high-performance liquid chromatography system with a mixed-mode column, eluting the blank with a gradient from a first mobile phase to a second mobile phase, and applying evaporative light-scattering detection to the blank after it exits the column. In some embodiments, the first mobile phase and the second mobile phase are as disclosed in the application.

In some embodiments, the blank produces a baseline signal. In some embodiments, the baseline signal is stable. In some embodiments, the stable baseline signal indicates the absence of polysorbate.

In some embodiments, after the first blank has been applied to the column and before applying the aliquot to be measured the column, the method further comprises applying a second blank onto the high-performance liquid chromatography system with a mixed-mode column, eluting the blank with a gradient from a first mobile phase to a second mobile phase, and applying evaporative light-scattering detection to the blank after it exits the column. In some embodiments, the first mobile phase and the second mobile phase are as disclosed in the application. In some embodiments, applying evaporative light-scattering detection to the second blank produces a stable baseline signal.

### Quantifiable Method

In some embodiments, the method further comprises quantifying the measured level of polysorbate in the sample.

In some embodiments, quantifying the measured level of polysorbate provides an accurate, robust measurement of the level of polysorbate in the sample.

In some embodiments, the method comprises quantifying the measured level of one polysorbate in the sample. Optionally, the quantified polysorbate is polysorbate 20, polysorbate 40, polysorbate 60, or polysorbate 80.

In some embodiments, the method comprises quantifying the measured level of polysorbate 20.

In some embodiments, the method comprises quantifying the measured level of polysorbate 80.

In some embodiments, the method comprises quantifying the measured levels of two or more polysorbates in the sample. Optionally, the two or more polysorbates are selected from polysorbate 20, polysorbate 40, polysorbate 60, and polysorbate 80. In some embodiments, the method comprises quantifying the measured levels of polysorbate 80 and polysorbate 20.

In some embodiments, quantifying the measured level of polysorbate comprises comparing the measured amount of polysorbate against a calibration curve.

In some embodiments, comparing the measured amount of polysorbate against a calibration curve yields a quantity of polysorbate in the sample.

In some embodiments, comparing the measured amount of polysorbate against the calibration curve identifies a quantity of polysorbate in the aliquot.

In some embodiments, the calibration curve is generated by separately applying two or more concentration standards comprising known amounts of polysorbate onto a high performance liquid chromatography system with a mixed-mode column, eluting the concentration standards with a gradient from a first mobile phase to a second mobile phase, and applying evaporative light-scattering detection to the concentration standards as each exits the column, thereby measuring polysorbate levels, and generating a calibration curve from the measured levels of polysorbate in the concentration standards. In some embodiments, the mobile phases are as described in the application.

In some embodiments, each concentration standard comprises the same polysorbate. In some embodiments, each concentration standard comprises polysorbate 80. In some embodiments, each concentration standard comprises polysorbate 20.

In some embodiments, each concentration standard comprises two or more polysorbates.

In some embodiments, calibration curves are generated for two or more different polysorbates, and the method measures the levels of each of the two or more polysorbates in the samples.

In some embodiments, one or more of the concentration standards produces a larger signal that the aliquot and one or more of the concentration standards produces a smaller signal than the aliquot. In some embodiments, having one or more concentration standards producing a larger signal than the aliquot and one or more concentration standards producing a smaller signal than the aliquot provides a more accurate method compared to a method wherein the concentrations standards do not produce larger and smaller signals than the aliquot.

In some embodiments, the maximum amount of polysorbate in the one or more concentration standards does not exceed the maximum detectable signal for evaporative light-scattering detection. In some embodiments, this produces a more reliable calibration curve.

In some embodiments, the largest amount of polysorbate has a peak height of about 80% of the maximum detectable signal.

In some embodiments, applying evaporative light-scattering detection to a blank produces a signal that is lower than a signal produced by the concentration standard comprising the smallest amount of polysorbate.

In some embodiments, the calibration curve is generated using three or more, four or more, five or more, or six or more concentration standards.

In some embodiments, the calibration curve is prepared gravimetrically. In some embodiments, a calibration curve is prepared gravimetrically by weighing the stock standard and dilution solvent.

In some embodiments, the calibration curve has a coefficient of determination (R²) greater than or equal to 0.995. In some embodiments, the coefficient of determination (R²) is greater than or equal to 0.998.

In some embodiments, the correlation coefficient (R) is greater than or equal to 0.997. In some embodiments, the correlation coefficient (R) is greater than or equal to 0.999.

In some embodiments, the calibration curve is prepared using a quadratic fit through zero.

In some embodiments, the percentage relative standard deviation of two or more aliquots of the sample is 10 or less. In some embodiments, the percentage relative standard deviation of two or more aliquots is 8 or less, 6 or less, 4 or less, 2 or less, or 1 or less.

In some embodiments, the blanks, concentration standards and aliquots of one or more samples are applied to the column according to the method of the disclosure in one or more of the following sequences. In some embodiments, at least two blanks are applied. Optionally the blanks comprise purified water. In some embodiments, a high protein concentration equilibration standard comprising polysorbate is applied at least twice for the purpose of equilibration. In some embodiments, at least three further blanks comprising water are applied. In some embodiments, concentration standards are applied sequentially, from which the calibration curve is generated. In some embodiments, a further blank comprising water is applied. In some embodiments, a local reference standard comprising a known amount of polysorbate is applied. In some embodiments, a further blank comprising water is applied. In some embodiments, a check standard is applied, wherein the check standard comprises a known amount of polysorbate that is measured against the calibration curve to confirm accuracy prior to applying one or more aliquots to the column. In some embodiments, aliquots of one or more samples are applied sequentially. In some embodiments, a further check standard is applied to the column after applying the one or more aliquots to the column.

In some embodiments, the method comprises applying a first polysorbate concentration standard onto a high performance liquid chromatography system with a mixed-mode column, eluting the sample with a gradient from a first mobile phase to a second mobile phase, and applying evaporative light-scattering detection to the eluant after it exits the column, thereby measuring polysorbate levels; applying one or more further polysorbate concentration standards comprising different known amounts of polysorbate compared to the first concentration standard onto a high performance liquid chromatography system with a mixed-mode column, eluting the sample with a gradient from a first mobile phase to a second mobile phase, and applying evaporative light-scattering detection to the eluant after it exits the column, thereby measuring polysorbate levels; generating a calibration curve from the measured polysorbate levels in the polysorbate concentration standards; applying an aliquot of the sample onto a high performance liquid chromatography system with a mixed-mode column; eluting the sample with a gradient from a first mobile phase to a second mobile phase; and applying evaporative light-scattering detection to the eluant after it exits the column, thereby measuring polysorbate levels; and quantifying the amount of polysorbate in the aliquot of the sample by comparison against the calibration curve. In some embodiments, the first mobile phase comprises 2% formic acid, 20% acetonitrile, and 78% purified water and the second mobile phase comprises 2% formic acid and 98% isopropyl alcohol.

It is to be understood that the examples and embodiments described herein are for illustrative purposes only and that various modifications or changes in light thereof will be known to persons skilled in the art and are to be included within the spirit of the application and the scope of the appended claims.

The present disclosure provides an improved method for measuring polysorbate levels in a sample. The method of the disclosure provides consistent results meeting all of the acceptance criteria set out in Table 3. Without being bound by theory, it is believed that the mobile phases and gradient programs disclosed herein contribute to achieving the acceptance criteria set out in Table 3.

In some embodiments, the mobile phases of the disclosure effectively remove trace amounts of protein. In some embodiments, the addition of acetonitrile to the first mobile phase effectively removes trace amounts of protein.

In some embodiments, the mobile phases of the disclosure effectively remove trace amounts of matrix components.

In some embodiments, the gradient programs of the disclosure improve the method to meet the acceptance criteria set out in Table 3.

In some embodiments, the volume of the aliquot improves the method to meet the acceptance criteria set out in Table 3.

TABLE 1
Acceptance Criteria

| | |
|---|---|
| Blank injection | A stable baseline must be observed |
| Calibration Curve | Chromatography comparable to reference in method |
| | Acceptance criteria: R² ≥ 0.995 |
| Control sample | Measured amount of polysorbate for the initial control |
| | must be ±20% of theoretical polysorbate amount. |
| | Relative standard deviation of multiple check standard |
| | injections must be ≤10% |

### ENUMERATED EMBODIMENTS

Embodiment 1. A method for measuring polysorbate levels in a sample, the method comprising: applying an aliquot of the sample onto a high performance liquid chromatography system with a mixed-mode column; eluting the sample with a gradient from a first mobile phase to a second mobile phase; and applying evaporative light-scattering detection to the eluant after exiting the column, thereby measuring polysorbate levels; wherein the first mobile phase comprises: 0-20% of an acid; 1-70% of an organic solvent selected from acetonitrile, methanol, tetrahydrofuran, isopropyl alcohol, or mixtures thereof; and water; and wherein the second mobile phase comprises: 0-20% of an acid; 80-100% of an organic solvent selected from acetonitrile, methanol, tetrahydrofuran, isopropyl alcohol, or mixtures thereof; and optionally water.

Embodiment 2. The method according to Embodiment 1, wherein the acid is a volatile acid.

Embodiment 3. The method according to Embodiment 2, wherein the volatile acid is formic acid.

Embodiment 4. The method according to any one of the preceding Embodiments, wherein the first mobile phase and/or the second mobile phase comprises 0-2% acid.

Embodiment 5. The method according to any one of the preceding Embodiments, wherein the organic solvent in the first mobile phase is different from the organic solvent in the second mobile phase.

Embodiment 6. The method according to any one of the preceding Embodiments, wherein the first mobile phase comprises 2% formic acid, 20% acetonitrile, and 78% purified water.

Embodiment 7. The method according to any one of the preceding Embodiments, wherein the second mobile phase comprises 2% formic acid and 98% isopropyl alcohol.

Embodiment 8. The method according to any one of the preceding Embodiments, wherein the measured polysorbate comprises polysorbate 20, polysorbate 40, polysorbate 60, and/or polysorbate 80.

Embodiment 9. The method according to any one of the preceding Embodiments, wherein the measured polysorbate comprises polysorbate 20 and/or polysorbate 80.

Embodiment 10. The method according to any one of the preceding Embodiments, wherein the measured polysorbate comprises polysorbate 20.

Embodiment 11. The method according to any one of the preceding Embodiments, wherein the measured polysorbate comprises polysorbate 80.

Embodiment 12. The method according to any one of the preceding Embodiments, further comprising, before applying the aliquot to be measured to the column: applying a blank onto a high performance liquid chromatography system with a mixed-mode column; eluting the blank with a gradient from a first mobile phase to a second mobile phase; and applying evaporative light-scattering detection to the blank after exiting the column; wherein the first mobile phase comprises: 0-20% of an acid; 1-70% of an organic solvent selected from acetonitrile, methanol, tetrahydrofuran, isopropyl alcohol, or mixtures thereof; and water; and wherein the second mobile phase comprises: 0-20% of an acid; 80-100% of an organic solvent selected from acetonitrile, methanol, tetrahydrofuran, isopropyl alcohol, or mixtures thereof; and optionally water.

Embodiment 13. The method according to Embodiment 12, wherein applying evaporative light-scattering detection to the blank produces a baseline signal.

Embodiment 14. The method according to Embodiment 12 or Embodiment 13, further comprising, after the first blank has been applied to the column and before applying the aliquot to be measured to the column: applying a second blank onto a high-performance liquid chromatography system with a mixed-mode column; eluting the blank with a gradient from a first mobile phase to a second mobile phase; and applying evaporative light-scattering detection to the blank after exiting the column; wherein the first mobile phase comprises: 0-20% of an acid; 1-70% of an organic solvent selected from acetonitrile, methanol, tetrahydrofuran, isopropyl alcohol, or mixtures thereof; and water; and wherein the second mobile phase comprises: 0-20% of an acid; 80-100% of an organic solvent selected from acetonitrile, methanol, tetrahydrofuran, isopropyl alcohol, or mixtures thereof; and optionally water; wherein applying evaporative light-scattering detection to the second blank produces a stable baseline signal.

Embodiment 15. The method according to any one of the preceding Embodiments, wherein the first mobile phase and/or the second mobile phase was prepared within 2 weeks of performing the method.

Embodiment 16. The method according to any one of the preceding Embodiments, further comprising quantifying the measured level of polysorbate in the sample.

Embodiment 17. The method according to Embodiment 16, wherein quantifying the measured level of polysorbate in the sample comprises comparing the measured amount of polysorbate against a calibration curve.

Embodiment 18. The method according to Embodiment 17, wherein comparing the measured amount of polysorbate against the calibration curve identifies a quantity of polysorbate in the aliquot.

Embodiment 19. The method according to Embodiment 17 or Embodiment 18, wherein the calibration curve is generated by: separately applying one or more concentration standards comprising known amounts of polysorbate onto a high performance liquid chromatography system with a mixed-mode column; eluting the concentration standards with a gradient from a first mobile phase to a second mobile phase; and applying evaporative light-scattering detection to the concentration standards after each exits the column, thereby measuring polysorbate levels; and generating a calibration curve from the measured levels of polysorbate in the concentration standards; wherein the first mobile phase comprises: 0-20% of an acid; 1-70% of an organic solvent selected from acetonitrile, methanol, tetrahydrofuran, isopropyl alcohol, or mixtures thereof; and water; and wherein the second mobile phase comprises: 0-20% of an acid; 80-100% of an organic solvent selected from acetonitrile, methanol, tetrahydrofuran, isopropyl alcohol, or mixtures thereof; and optionally water.

Embodiment 20. The method according to Embodiment 19, wherein one or more of the concentration standards produces a larger signal than the aliquot and one or more of the concentration standards produces a smaller signal than the aliquot.

Embodiment The method according to Embodiment 19 or Embodiment 20, wherein the amount of polysorbate in the two or more concentration standards does not exceed the maximum detectable signal for evaporative light-scattering detection.

Embodiment 22. The method according to any one of Embodiments 19-21, wherein the amount of polysorbate in the concentration standard comprising the largest amount of polysorbate has a peak height of about 80% of the maximum detectable signal.

Embodiment 23. The method according to any one of Embodiments 19-22, wherein applying evaporative light-scattering detection to a blank produces a signal that is lower than a signal produced by the concentration standard comprising the smallest amount of polysorbate.

Embodiment 24. The method according to any one of Embodiments 19-23, wherein the calibration curve is generated using three or more, four or more, five or more, or six or more concentration standards.

Embodiment 25. The method according to any one of Embodiments 17-24, wherein the calibration curve is prepared gravimetrically.

Embodiment 26. The method according to any one of Embodiments 17-25, wherein the calibration curve has a coefficient of determination (R²) greater than or equal to 0.995.

Embodiment 27. The method according to Embodiment 26, wherein the coefficient of determination is greater than or equal to 0.998.

Embodiment 28. The method according to any one of Embodiments 17-27, wherein the calibration curve is prepared using a quadratic fit through zero.

Embodiment 29. The method according to any one of the preceding Embodiments, wherein the percentage relative standard deviation of two or more aliquots of the sample is 10 or less.

Embodiment 30. The method according to any one of the preceding Embodiments, wherein the gradient comprises: 100% first mobile phase and 0% second mobile phase from 0.0 minutes to 2.0 minutes; 85% first mobile phase and 15% second mobile phase from 2.1 minutes to 5.0 minutes; 30% first mobile phase and 70% second mobile phase from 5.1 minutes to 7.6 minutes; 0% first mobile phase and 100% second mobile phase from 7.7 minutes to 9.0 minutes; and/or 100% first mobile phase and 0% second mobile phase from 9.1 minutes to 10.0 minutes.

Embodiment 31. The method according to any one of the preceding Embodiments, wherein the sample is applied onto the mixed-mode column at a temperature of 22-28 °C.

Embodiment 32. The method according to any one of the preceding Embodiments, wherein the eluant is eluted from the column with a flow rate of 0.9-1.1 mL/min.

Embodiment 33. The method according to any one of the preceding Embodiments, wherein the evaporative light-scattering detection utilizes an Alltech 3300 detector.

Embodiment 34. The method according to Embodiment 33, wherein the method is performed using a nebulizer temperature of the detector of 68-72 °C.

Embodiment 35. The method according to Embodiment 33 or Embodiment 34, wherein the method is performed using a gas flow rate of the detector of 2.3-2.7 L/min.

Embodiment 36. The method according to any one of Embodiments 1-32, wherein the evaporative light-scattering detection utilizes an Agilent 1260 evaporative light-scattering detector.

Embodiment 37. The method according to Embodiment 36, wherein the method is performed using a nebulizer temperature of the detector of 43-47 °C.

Embodiment 38. The method according to Embodiment 36 or Embodiment 37, wherein method is performed using a heating tube temperature of the detector of 70-90 °C.

Embodiment 39. The method according to any one of Embodiments 36-38, wherein the method is performed using a gas flow of the detector of 1.3-1.7 L/min.

Embodiment 40. The method according to any one of the preceding Embodiments, wherein the sample is a drug substance.

Embodiment 41. The method according to any of Embodiments 1-39, wherein the sample is a drug product.

Embodiment 42. A method for quantifying polysorbate levels in a sample, the method comprising: applying a first polysorbate concentration standard onto a high performance liquid chromatography system with a mixed-mode column, eluting the sample with a gradient from a first mobile phase to a second mobile phase, and applying evaporative light-scattering detection to the eluant after exiting the column, thereby measuring polysorbate levels; applying one or more further polysorbate concentration standards comprising different known amounts of polysorbate compared to the first concentration standard onto a high performance liquid chromatography system with a reversed-mixed-mode column, eluting the sample with a gradient from a first mobile phase to a second mobile phase, and applying evaporative light-scattering detection to the eluant after exiting the column, thereby measuring polysorbate levels; generating a calibration curve from the measured polysorbate levels in the polysorbate concentration standards; applying an aliquot of the sample onto a high performance liquid chromatography system with a mixed-mode column, eluting the sample with a gradient from a first mobile phase to a second mobile phase; and applying evaporative light-scattering detection to the eluant after exiting the column, thereby measuring polysorbate levels; and quantifying the amount of polysorbate in the aliquot of the sample by comparison against the calibration curve; wherein the first mobile phase comprises 2% formic acid, 20% acetonitrile, and 78% purified water and the second mobile phase comprises 2% formic acid and 98% isopropyl alcohol.

Embodiment 43. The method of Embodiment 40, wherein the method is practiced according to any one of Embodiments 8-15 or 20-41.

### EXAMPLES

The following examples serve only to illustrate the methods of the disclosure and are not intended to limit the scope of the disclosure, which is as set out in the claims.

### Example 1

Example 1 provides an exemplary application of the method of the disclosure.

A method of the disclosure was exemplified with an exemplary sample comprising an antibody in a matrix comprising polysorbate 80.

A calibration curve was generated using standards comprising known amounts of polysorbate 80.

The sample was a high protein concentration sample comprising polysorbate 80 equilibration sample.

A mixed-mode column was selected. Specifically, the exemplified column was a Waters Oasis Max Online Column, 3 mm×20 mm, 30 μm, part number: 186002053.

The first mobile phase for high performance liquid chromatography comprised 2% formic acid, 20% acetonitrile, and 78% purified water. The reagents were added and mixed well and kept at ambient conditions for up to 2 weeks.

The second mobile phase comprised 2% formic acid in isopropyl alcohol. 20 mL formic acid was added into 980 mL of isopropyl alcohol and mixed well. The second mobile phase was kept for 2 weeks at ambient conditions.

An injector wash/needle dip was applied, using 95:5 H₂O:isopropyl alcohol.

The Agilent 1200/1260 series high performance liquid chromatography system with an evaporative light-scattering detector (ELSD) was utilized for measuring polysorbate. The Agilent 1260 Infinity II was used as the high-performance liquid chromatography system.

A standard curve was prepared gravimetrically using the concentration standards described in Table 4. The skilled person would appreciate that a calibration curve could readily be produced utilizing polysorbate concentration standards with different concentrations, and/or using a different number of concentration standards, and that the following standards are merely exemplary.

TABLE 2

| | Volume of | | Polysorbate |
|---|---|---|---|
| | polysorbate | Volume of | 80 working |
| | 80 reference | purified | standard |
| Concentration | standard | water | concentration |
| standard | (μL) | (μL) | (% w/v) |
| STD 1 | 50 | 740 | 0.005 |
| STD 2 | 100 | 690 | 0.01 |
| STD 3 | 200 | 590 | 0.02 |
| STD 4 | 300 | 490 | 0.03 |
| STD 5 | 400 | 390 | 0.04 |
| STD 6 | 500 | 290 | 0.05 |
| STD 7 | 600 | 190 | 0.06 |
| Check STD | 400 | 390 | 0.04 |

The concentration standards were stable for up to 3 days at ambient or refrigerated (2-8 °C) conditions.

All samples, blanks, and concentration standards were allowed to equilibrate to ambient temperature and were mixed well by inversion.

Aliquots were transferred to an HPLC vial.

Evaporative light-scattering detection settings were selected such that the highest concentration standard would not exceed the full scale.

The highest concentration standard had a peak height of ~80% of full scale. This represented a preferred position between sensitivity and range.

Detector gain was adjusted to achieve desired sensitivity.

A steam wash of the evaporative light-scattering detector was performed with 100% purified water prior to the analytical run for 1 hour at a flow rate of 1 mL/min. The detector settings for the steam wash were: gas flow of 1.3 SLM, evaporation temperature of 100 °C, and a nebulizer temperature of 50 °C.

The column temperature was 25 °C and the autosampler temperature was 5 °C.

An aliquot of 20 μL was applied to the column.

The evaporative light-scattering detector had a gas flow of 1.5 SLM, a nebulizer temperature of 45 °C, an evaporation temperature of 80 °C, a time constant of 30, a data output rate of 10 Hz, and a detector gain of 1.

A flush port was applied. If running the method with a flush port, for example on Agilent 1260 Infinity II, use of the flush port was selected instead of a wash vial. Injector wash was used with the flush port and injector wash time was increased from the default of 3 seconds, as needed.

The run time was 10 minutes, using the gradient program of Table 5.

TABLE 5

| | % first | % second |
|---|---|---|
| Time | mobile | mobile |
| (minutes) | phase | phase |
| 0.0 | 100 | 0 |
| 2.0 | 100 | 0 |
| 2.1 | 85 | 15 |
| 5.0 | 85 | 15 |
| 5.1 | 30 | 70 |
| 7.6 | 30 | 70 |
| 7.7 | 0 | 100 |
| 9.0 | 0 | 100 |
| 9.1 | 100 | 0 |
| 10.0 | 100 | 0 |

The blanks, concentration standards, and one or more samples were applied according to the method of the disclosure, in the sequence set out in Table 6.

TABLE 3

| | Number of |
|---|---|
| | applications |
| Solution | (injections) |
| Blank (water) | at least 2 |
| Equilibration | at least 2 |
| (STD 7 - polysorbate 80 standard 0.06% w/v) | |
| Blank (water) | at least 3 |
| STD 1 (polysorbate 80 standard 0.005% w/v) | 1 |
| STD 2 (polysorbate 80 standard 0.01% w/v) | 1 |
| STD 3 (polysorbate 80 standard 0.02% w/v) | 1 |
| STD 4 (polysorbate 80 standard 0.03% w/v) | 1 |
| STD 5 (polysorbate 80 standard 0.04% w/v) | 1 |
| STD 6 (polysorbate 80 standard 0.05% w/v) | 1 |
| STD 7 (polysorbate 80 standard 0.06% w/v) | 1 |
| Blank (water) | 1 |
| Control Sample (inject neat) | 1 |
| Blank (water) | at least 1 |
| Check STD (0.04% polysorbate 80 w/v) | 1 |
| Sample (inject neat) | 1 each |
| Check STD (0.04% polysorbate 80 w/v) | 1 |

Concentration standards and samples were integrated with a straight baseline.

Alternative exemplary sequences would be evident to the person skilled in the art. The person skilled in the art would appreciate that the exemplified sequence of injections is an example and should not be deemed to limit the scope of the claims in any manner.

The skilled person would appreciate that the method is applicable for other polysorbates, including but not limited to polysorbate 20, polysorbate 40, and polysorbate 60.

Acceptance criteria were provided against which the method was assessed. The acceptance criteria are set out in Table 3.

The blank applied immediately before the standards was evaluated. To meet the acceptance criteria, a stable baseline must be observed. A stable baseline was observed in two injections prior to the first standard.

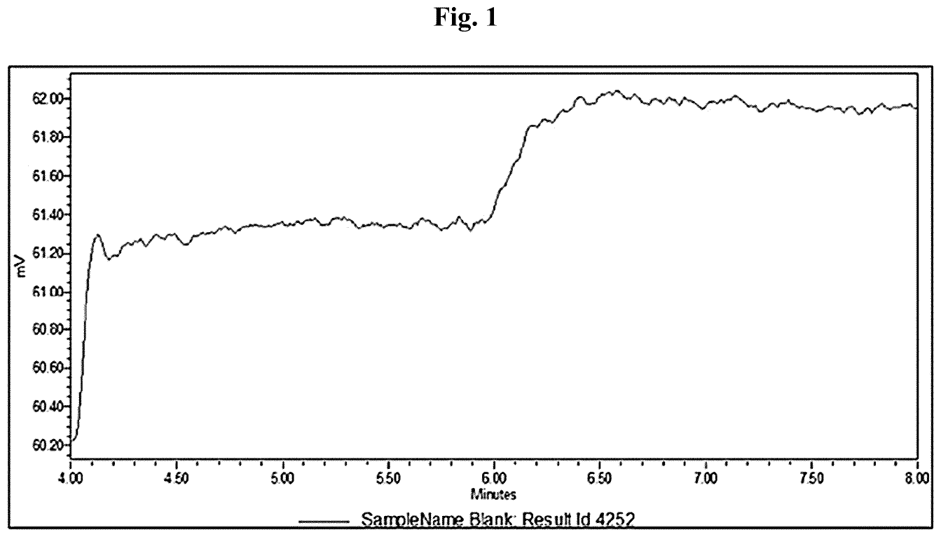

The blank chromatogram was comparable to the exemplified chromatogram in FIG. 1.

It is normal to have a peak in the water blank at the retention time of polysorbate 80. If a peak is present in the blank, it should be less than the peak produced by the standard comprising the lowest concentration of polysorbate 80.

A control sample that did not comprise polysorbate 80 was also evaluated. The control sample did not have an interfering peak corresponding to an equivalent level of more than 0.005% polysorbate 80, so met the acceptance criteria.

Chromatographic non-interference of the Local Reference Standard was also evaluated. The acceptance criterion for the local reference standard interference is that any interfering peak in the local reference standard is less than the standard comprising the lowest amount of polysorbate.

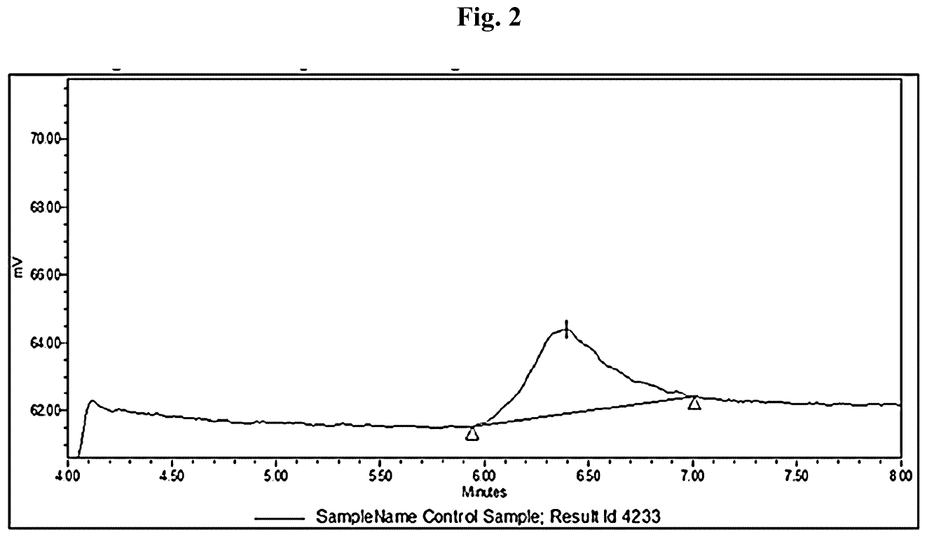

The chromatogram for the local reference standard is provided in FIG. 2.

The calibration curve generated from the concentration standards was evaluated. The chromatographic profile of each standard and the correlation coefficient of the calibration curve were evaluated.

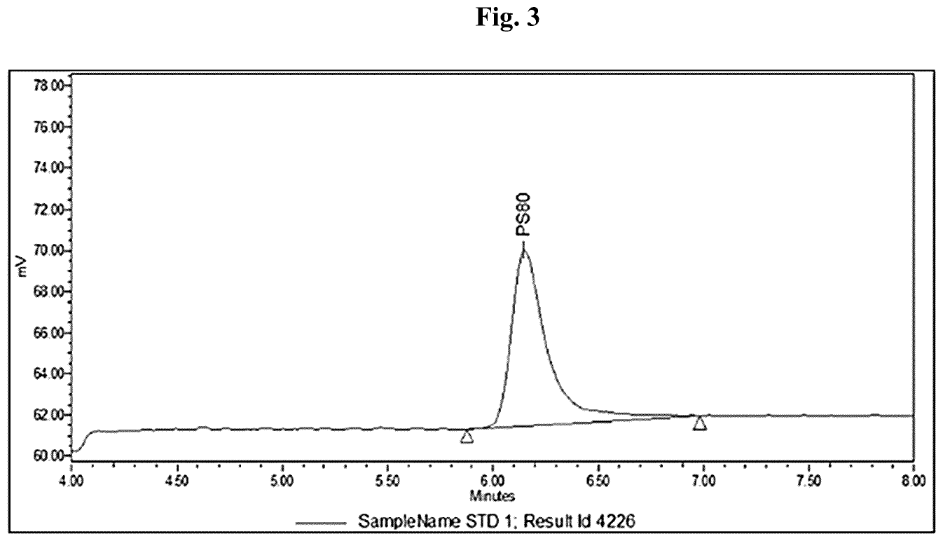

The chromatographic profile was comparable to FIG. 3 and was therefore acceptable.

An R²≥0.995 was considered acceptable (quadratic fit through zero).

The Check STD was evaluated against the calibration curve. Acceptance criteria was a measured amount of polysorbate 80% (w/v) of ±20% of the theoretical amount of polysorbate calculated from the percentage difference from theory equation set forth below:

$$\frac{\begin{matrix}Theoretical polysorbate 80 concentration ( \% w / v ) - \\ Measured polysorbate 80 concentration ( \% w / v )\end{matrix}}{Theoretical polysorbate 80 concentration ( \% w / v )} \times 100$$

The calibration curve was generated as a quadratic fit through zero using validated software of concentration vs. peak area.

The concentration of polysorbate 80 in the sample was determined from the quadratic calibration curve.

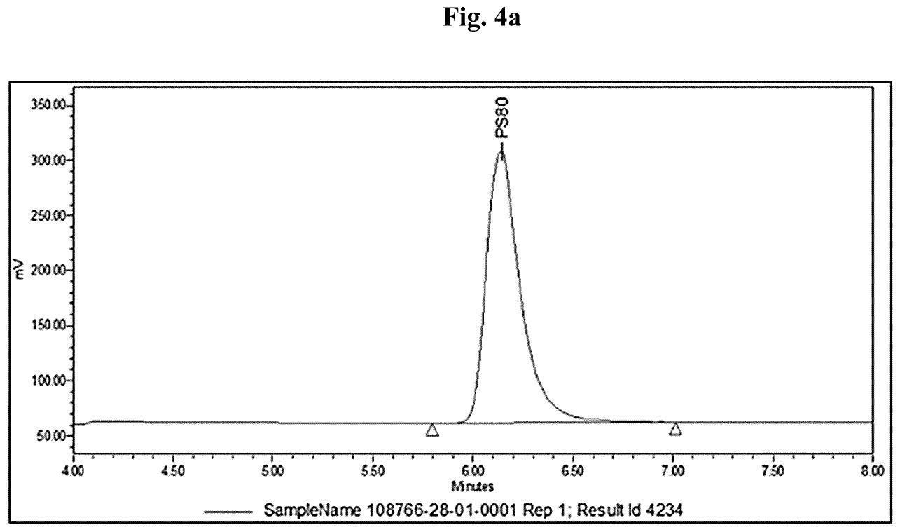

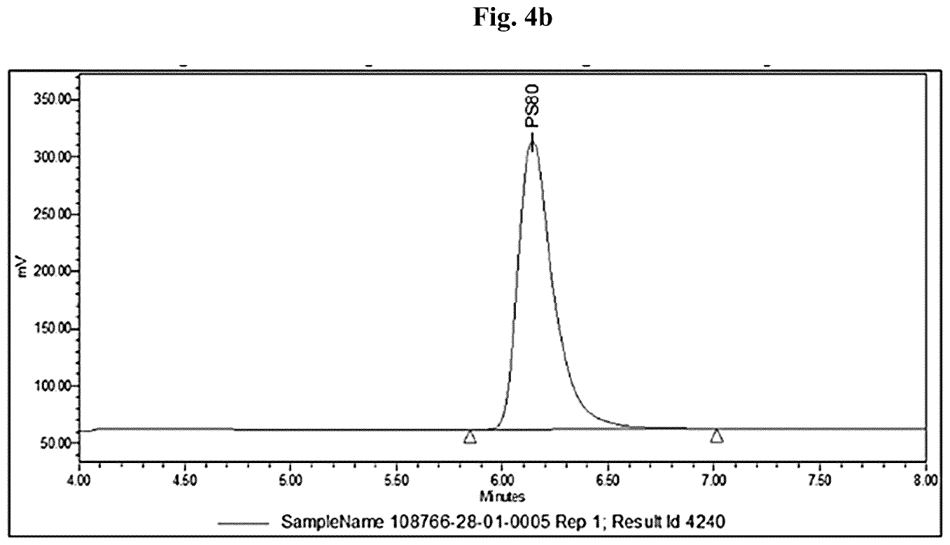

FIGS. 4a-b provide polysorbate 80 chromatograms. FIG. 4a provides a chromatogram from a drug substance sample. FIG. 4b provides a chromatogram from a drug product sample.

The skilled person would appreciate that the exemplified method of Example 1 could readily be applied to other polysorbates, including but not limited to polysorbate 20, polysorbate 40, and polysorbate 60.

### Example 2

Recovery of polysorbate 80 was measured to assess the robustness of the method of Example 1.

An initial test provided percentage recovery within 20% (Table 7).

TABLE 7

| | Theoretical | Initial test | | | Updated | | Updated |
|---|---|---|---|---|---|---|---|
| | polysorbate | polysorbate | Initial % | Updated | recovery | Updated | recovery |
| Sample | 80 | 80 | recovery | Run #1 | #1% | Run #1 | #2% |
| S1 | 0.05 | 0.059 | 118.000 | 0.050 | 99.760 | 0.050 | 99.778 |
| S2 | 0.05 | 0.06 | 120.000 | 0.051 | 102.364 | 0.050 | 99.812 |
| S3 | 0.05 | 0.021 | 105.000 | 0.019 | 95.560 | 0.019 | 93.070 |

A further update to the method further improved recovery to within 10% (Table 7).

Recovery for spiking samples also demonstrated robustness according to the acceptance criteria (Table 8). The spiking samples demonstrated percentage recovery from 105-109% for the updated runs.

TABLE 8

| | Theoretical | Initial test | | | Updated | | Updated |
|---|---|---|---|---|---|---|---|
| | polysorbate | polysorbate | Initial % | Updated | recovery | Updated | recovery |
| Sample | 80 | 80 | recovery | Run #1 | #1% | Run #1 | #2% |
| A1 | 0.0361 | 0.042 | 116.282 | 0.038 | 105.773 | 0.038 | 106.346 |
| A2 | 0.0399 | 0.046 | 115.306 | 0.042 | 106.382 | 0.043 | 109.034 |
| B1 | 0.0256 | 0.034 | 132.953 | 0.028 | 108.177 | 0.027 | 106.195 |
| B2 | 0.0244 | 0.031 | 127.029 | 0.026 | 105.581 | 0.026 | 106.864 |

### Example 3

The robustness of the method of Example 1 was assessed to investigate the impact of different parameters and ranges for the method, and the effect of utilizing different models and makes of evaporative light-scattering detectors.

A robustness study was undertaken to investigate parameters and ranges for the method of Example 1, using an Alltech 3300 and an Agilent 1260 evaporative light-scattering detector.

For the Alltech 3300 detector, different nebulizer temperatures were assessed for evaporative light-scattering detection, different column lots and column temperatures were assessed for the column, and different flow rates were assessed for the high-performance liquid chromatography. The assessed parameters were as set out in Table 9.

Two different Water Oasis Max Mixed-mode 3×20 mm, 30 μm column lots were evaluated. One column lot with prior injections and a second column lot with no prior injections were selected.

TABLE 9

| | | Parameter | |
|---|---|---|---|
| Step | Parameters | Range | |
| ELSD | Nebulizar Temperature | 72 | °C |
| | | 70 | °C |
| | | 68 | °C |
| | Gas Flow | 2.7 | L/min |
| | | 2.5 | L/min |
| | | 2.3 | L/min |
| Column | Different Column Lot | Lot A or | |
| | | Lot B | |
| | Column Temperature | 28 | °C |
| | | 25 | °C |
| | | 22 | °C |
| HPLC | Flow Rate | 0.9 | mL/min |
| | | 1.0 | mL/min |
| | | 1.1 | mL/min |

For the Agilent 1260 evaporative light-scattering detector, different nebulizer temperatures, heating tube temperatures, and gas flows were assessed for the evaporative light-scattering detector. The assessed parameters were as set out in Table 10.

TABLE 10

| Step | Parameters | Parameter Range |
|---|---|---|
| ELSD | Nebulizer | Nebulizer 47 °C, Heating Tube 90 °C |
| | Temperature, | Nebulizer 45 °C, Heating Tube 80 °C |
| | Heating Tube | Nebulizer 43 °C, Heating Tube 70 °C |
| | Gas Flow | 1.7 L/min |
| | | 1.5 L/min |
| | | 1.3 L/min |

A fractional factorial design of experiments was selected for the robustness study. The experimental design for the Alltech 3300 was as set out in Table 11. The experimental design for the Agilent 1260 evaporative light-scattering detector was as set out in Table 12.

TABLE 11

| | | Nebulizer | Gas | Colum | Column | Flow |
|---|---|---|---|---|---|---|
| Run | Pattern | Temperature | Flow | Lot | Temperature | Rate |
| 1 | 00−00 | 70 | 2.5 | Lot A | 25 | 1 |
| 2 | ++−−− | 72 | 2.7 | Lot A | 22 | 0.9 |
| 3 | −−+−− | 68 | 2.3 | Lot B | 22 | 0.9 |
| 4 | −+−+− | 68 | 2.7 | Lot A | 28 | 0.9 |
| 5 | 00−00 | 70 | 2.5 | Lot A | 25 | 1 |
| 6 | −−−++ | 68 | 2.3 | Lot A | 28 | 1.1 |
| 7 | +−++− | 72 | 2.3 | Lot B | 28 | 0.9 |
| 8 | 00+00 | 70 | 2.5 | Lot B | 25 | 1 |
| 9 | −++−+ | 68 | 2.7 | Lot B | 22 | 1.1 |
| 10 | +−−−+ | 72 | 2.3 | Lot A | 22 | 1.1 |
| 11 | +++++ | 72 | 2.7 | Lot B | 28 | 1.1 |
| 12 | 00+00 | 70 | 2.5 | Lot B | 25 | 1 |

TABLE 12

| Test | Temperature | Gas Flow |
|---|---|---|
| 1 | Nebulizer 47 °C, Heating Tube 90 °C | 1.7 |
| 2 | Nebulizer 46 °C. Heating Tube 80 °C | 1.5 |
| 3 | Nebulizer 43 °C, Heating Tube 70 °C | 1.3 |

The data confirmed that different evaporative light-scattering detector models and makers did not have any practical impact on the test results. Therefore, the method of the disclosure is effective irrespective of the model and/or make of the evaporative light-scattering detector.

The studies were executed in accordance with a robustness protocol.

System suitability acceptance criteria were defined for the method. The acceptance criteria were as defined in Table 3.

All robustness runs met the method suitability criteria.

USP tailing data was also collected for analysis.

System suitability results for the Alltech 3300 were as set out in Table 13. Tailing results for the beginning and end check standards ranged from 1.16 to 1.46 for the Alltech 3300.

R² was >0.999 for all runs, meeting the calibration curve acceptance criteria.

The check standard result for all samples indicated that the difference from the theoretical polysorbate amount was about 0.03% for all samples, which falls within the acceptance criterion.

TABLE 13

| | | | | | | | | | End | End |
|---|---|---|---|---|---|---|---|---|---|---|
| | | | | | | | Check | Check | Check | Check |
| | | | | | | | Standard | Standard | Standard | Standard |
| | Nebulizer | Gas | | | Flow | Standard | Result | USP | Result | USP |
| Run | Temp | Flow | Lot | Temp | Rate | Curve R² | (% PS80) | tailing | (% PS80) | tailing |
| 1 | 70 | 2.5 | Lot A | 25 | 1 | 0.9991 | 0.030 | 1.388 | 0.031 | 1.402 |
| 2 | 72 | 2.7 | Lot A | 22 | 0.9 | 0.9994 | 0.030 | 1.332 | 0.030 | 1.335 |
| 3 | 68 | 2.3 | Lot B | 22 | 0.9 | 0.9995 | 0.030 | 1.368 | 0.028 | 1.364 |
| 4 | 68 | 2.7 | Lot A | 28 | 0.9 | 0.9995 | 0.031 | 1.413 | 0.031 | 1.386 |
| 5 | 70 | 2.5 | Lot A | 25 | 1 | 0.9994 | 0.030 | 1.423 | 0.030 | 1.320 |
| 6 | 68 | 2.3 | Lot A | 28 | 1.1 | 0.9994 | 0.031 | 1.460 | 0.030 | 1.303 |
| 7 | 72 | 2.3 | Lot B | 28 | 0.9 | 0.9995 | 0.029 | 1.335 | 0.029 | 1.318 |
| 8 | 70 | 2.5 | Lot B | 25 | 1 | 0.9996 | 0.030 | 1.432 | 0.030 | 1.334 |
| 9 | 68 | 2.7 | Lot B | 22 | 1.1 | 0.9990 | 0.030 | 1.356 | 0.029 | 1.162 |
| 10 | 72 | 2.3 | Lot A | 22 | 1.1 | 0.9992 | 0.030 | 1.334 | 0.030 | 1.426 |
| 11 | 72 | 2.7 | Lot B | 28 | 1.1 | 0.9995 | 0.030 | 1.373 | 0.030 | 1.378 |
| 12 | 70 | 2.5 | Lot B | 25 | 1 | 0.9995 | 0.030 | 1.345 | 0.031 | 1.386 |

The 12 runs set out in Table 14 were run with three different samples, S2, S3, and D1, and statistical analysis was performed as described in Table 10. % PS80 was within 20% for all runs.

TABLE 14

| | | | | | | S2, | S3, | D1, |
|---|---|---|---|---|---|---|---|---|
| | Nebulizer | Gas | Column | Column | Flow | Result | Result | Result |
| Run | Temp | Flow | Lot | Temp | Rate | (% PS80) | (% PS80) | (% PS80) |
| 1 | 70 | 2.5 | Lot A | 25 | 1 | 0.050 | 0.019 | 0.023 |
| 2 | 72 | 2.7 | Lot A | 22 | 0.9 | 0.050 | 0.018 | 0.021 |
| 3 | 68 | 2.3 | Lot B | 22 | 0.9 | 0.049 | 0.018 | 0.020 |
| 4 | 68 | 2.7 | Lot A | 28 | 0.9 | 0.051 | 0.018 | 0.021 |
| 5 | 70 | 2.5 | Lot A | 25 | 1 | 0.051 | 0.019 | 0.015 |
| 6 | 68 | 2.3 | Lot A | 28 | 1.1 | 0.052 | 0.019 | 0.018 |
| 7 | 72 | 2.3 | Lot B | 28 | 0.9 | 0.050 | 0.019 | 0.017 |
| 8 | 70 | 2.5 | Lot B | 25 | 1 | 0.051 | 0.019 | 0.016 |
| 9 | 68 | 2.7 | Lot B | 22 | 1.1 | 0.050 | 0.017 | 0.016 |
| 10 | 72 | 2.3 | Lot A | 22 | 1.1 | 0.051 | 0.018 | 0.019 |
| 11 | 72 | 2.7 | Lot B | 28 | 1.1 | 0.051 | 0.020 | 0.021 |
| 12 | 70 | 2.5 | Lot B | 25 | 1 | 0.051 | 0.019 | 0.021 |

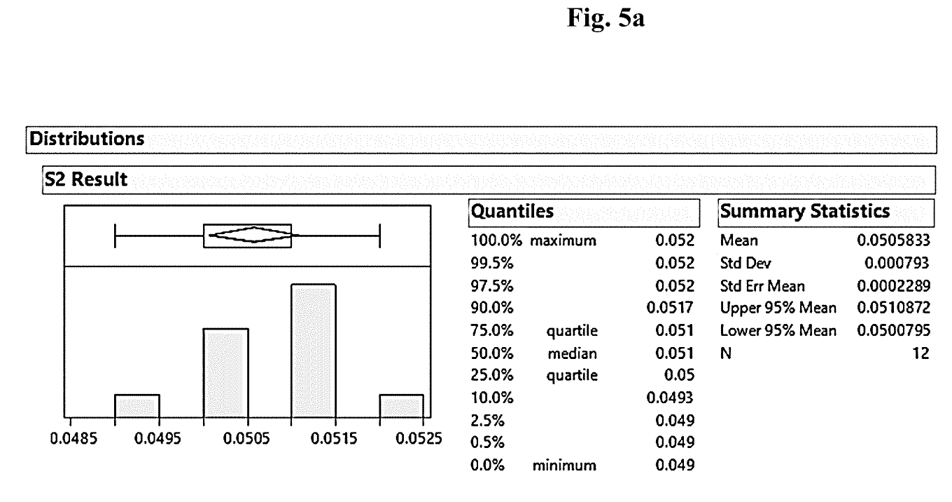

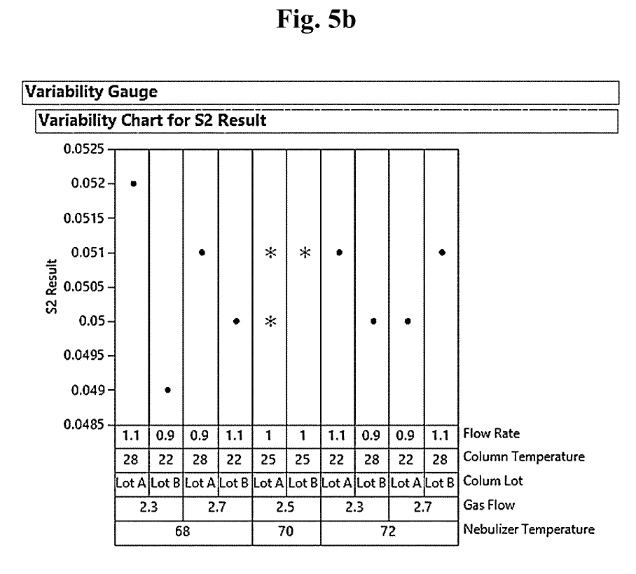

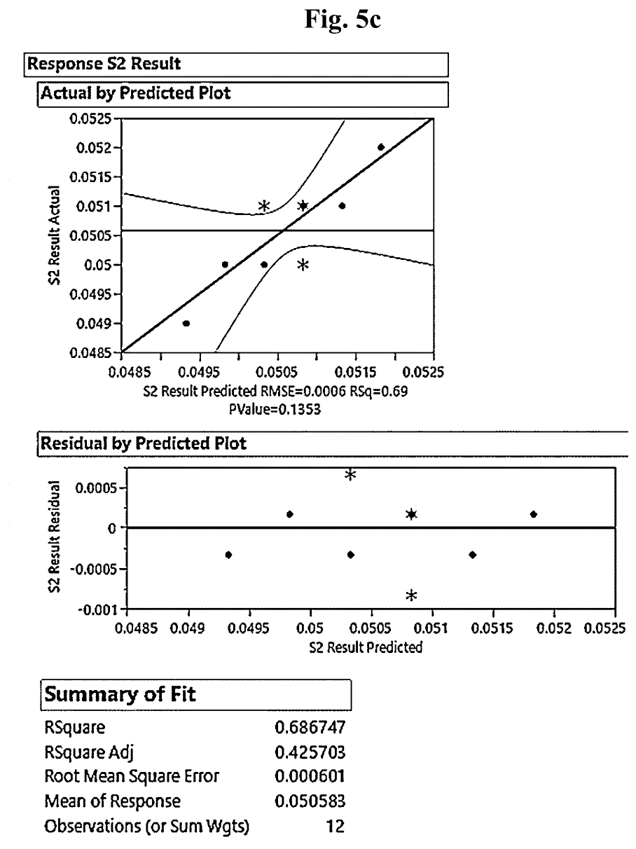

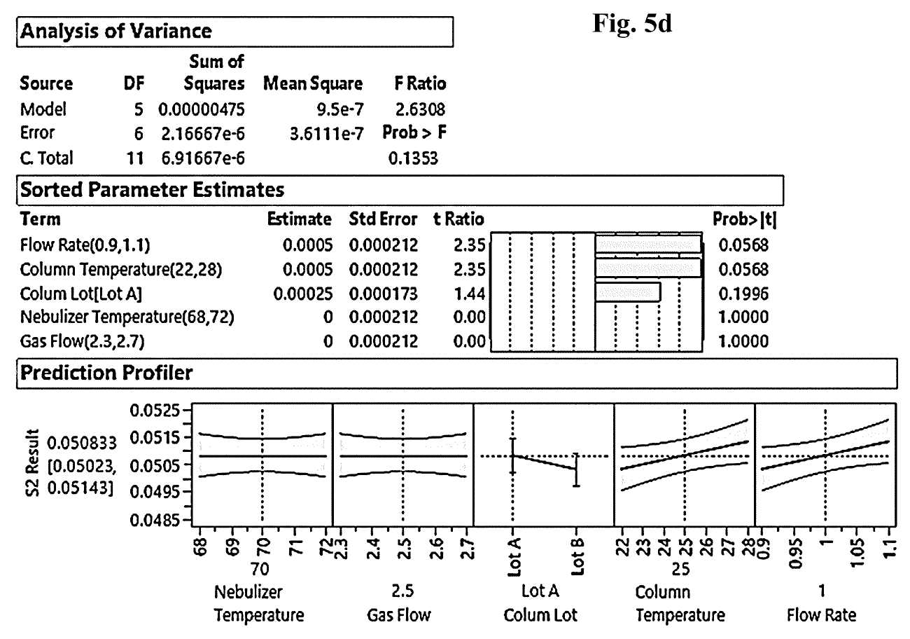

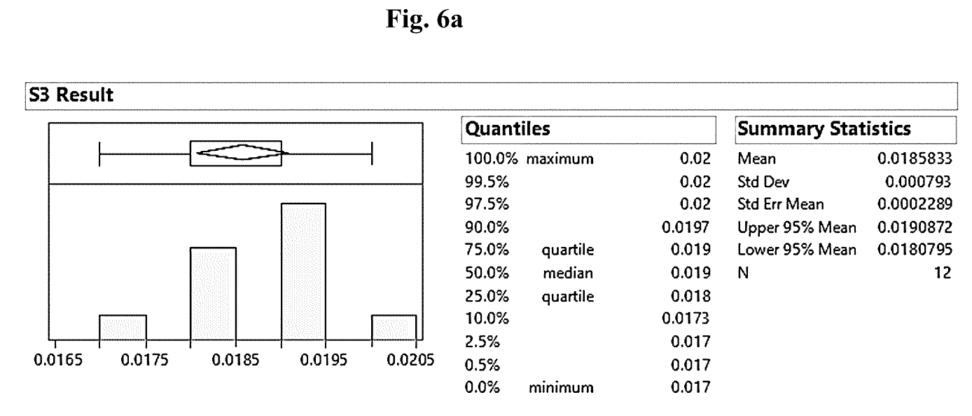

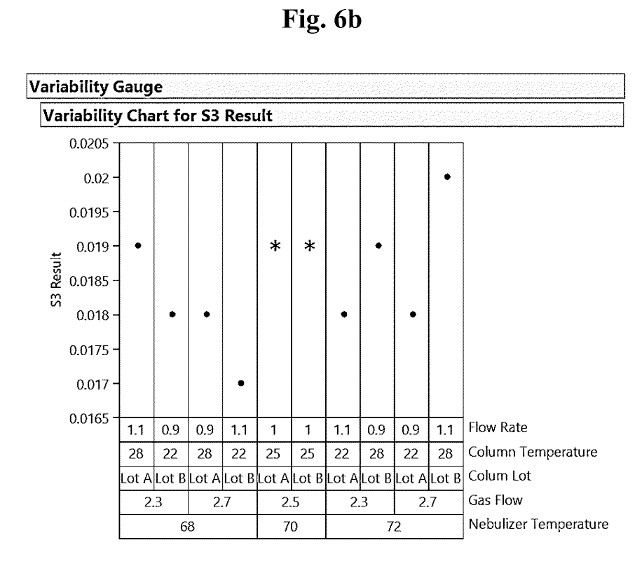

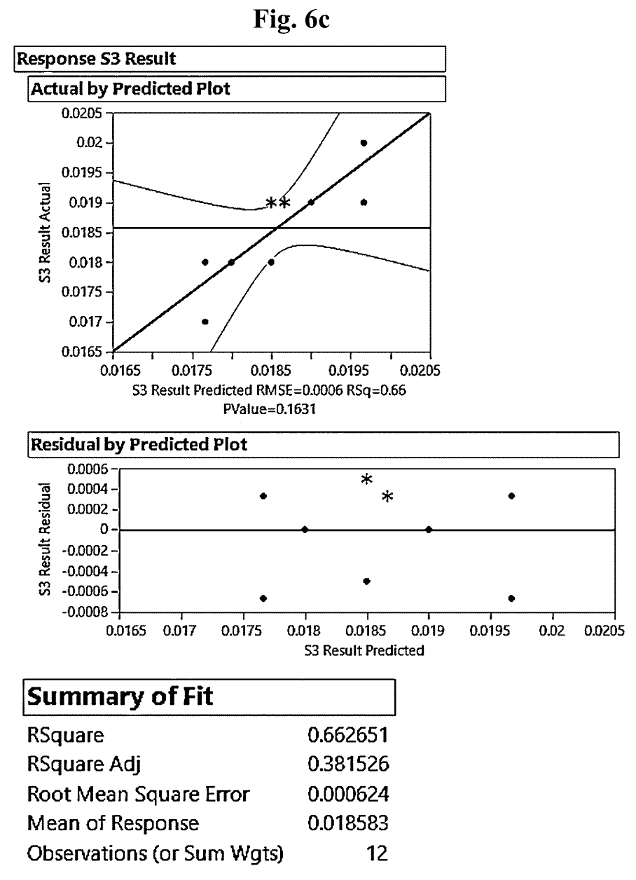

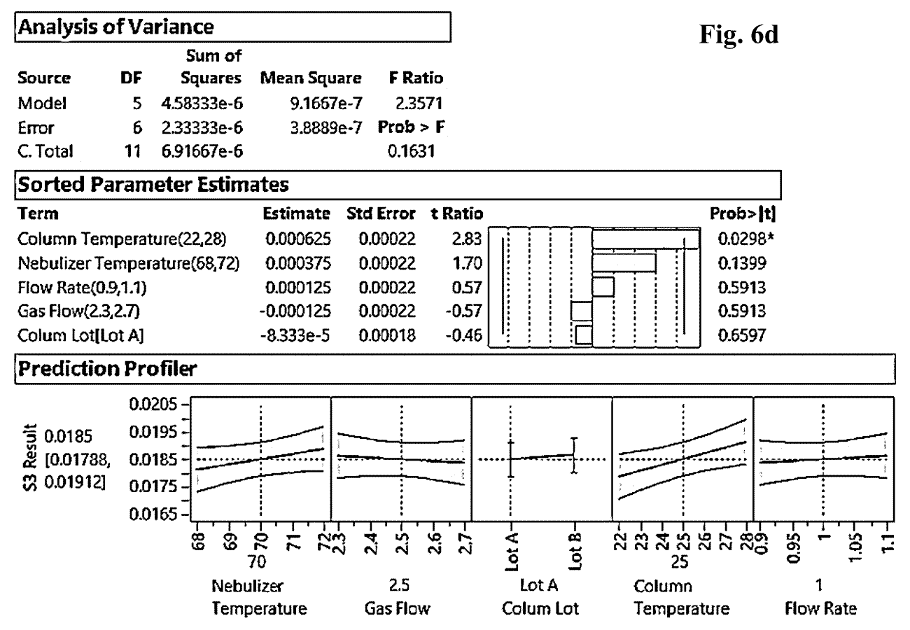

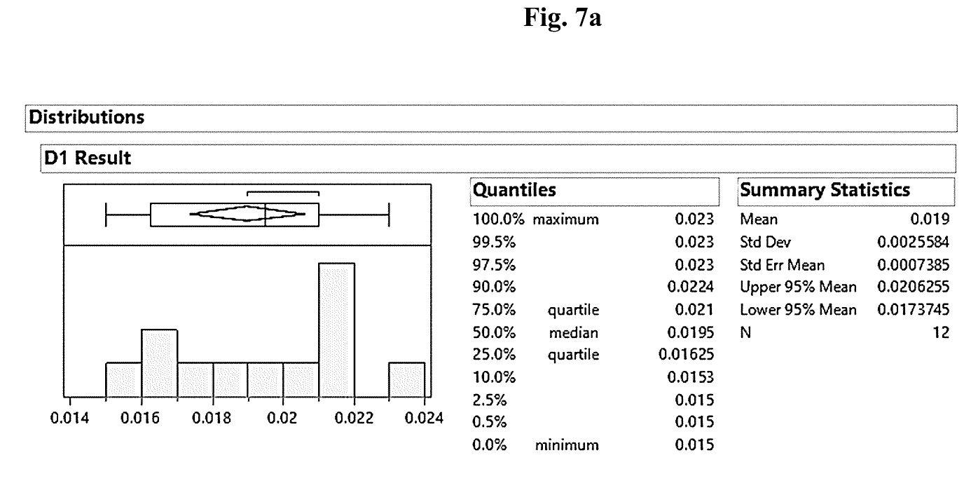

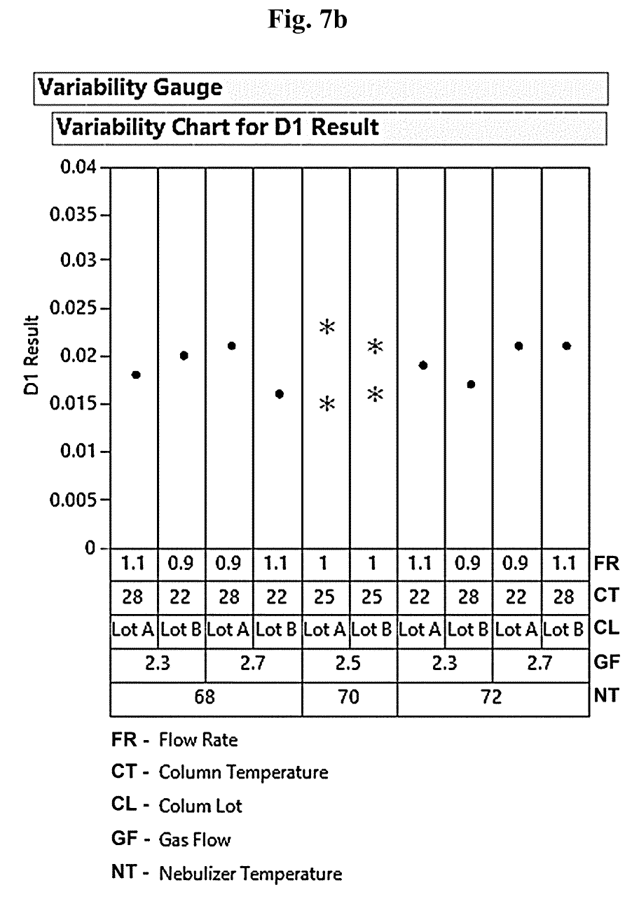

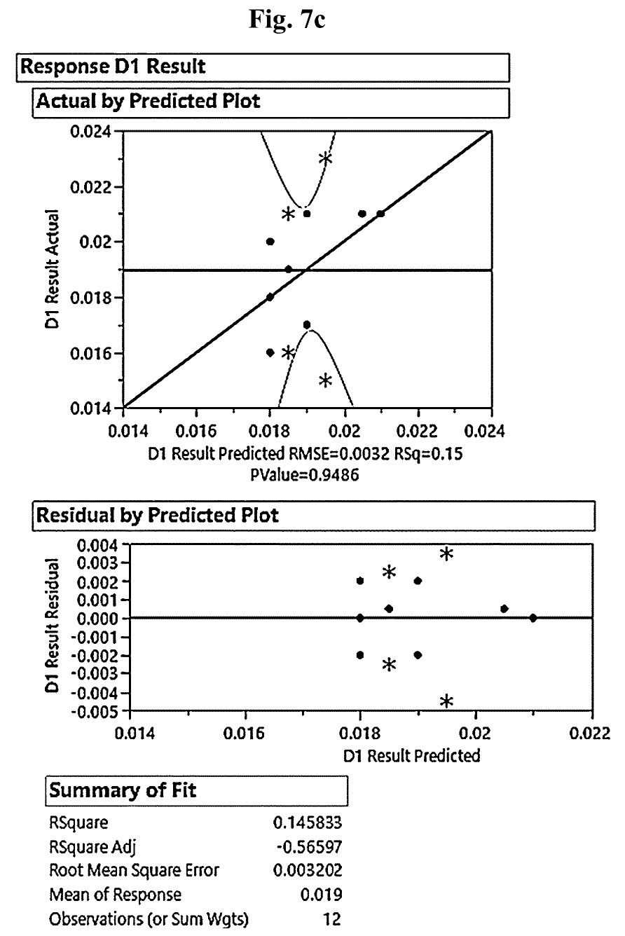

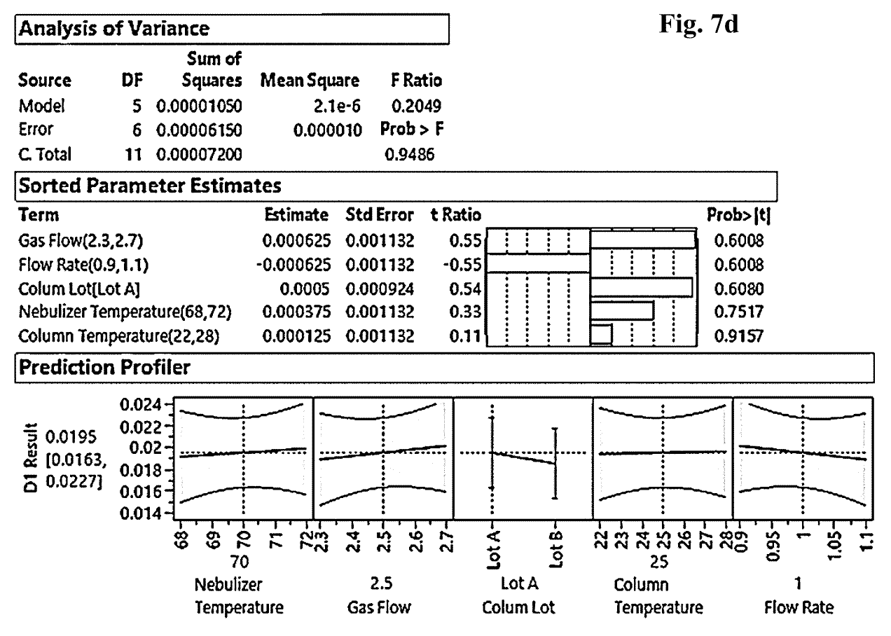

The corresponding JMP software analysis table is set out in Table 15A and Table 15B, and JMP statistical output is set out in FIGS. 5-7.

TABLE 15A

| | | | | | | | Standard |
|---|---|---|---|---|---|---|---|
| | | Nebulizer | Gas | | Column | Flow | Curve |
| Run | Pattern | Temp | Flow | Lot | Temp | Rate | R² |
| 1 | 000−00 | 70 | 2.5 | Lot A | 25 | 1 | 0.9991 |
| 2 | 000−00 | 70 | 2.5 | Lot A | 25 | 1 | 0.9994 |
| 3 | 000−00 | 70 | 2.5 | Lot A | 25 | 1 | 0.9991 |
| 4 | 000−00 | 70 | 2.5 | Lot A | 25 | 1 | 0.9994 |
| 5 | −−−−++ | 68 | 2.3 | Lot A | 28 | 1.1 | 0.9994 |
| 6 | 000+00 | 70 | 2.5 | Lot B | 25 | 1 | 0.9996 |
| 7 | 000+00 | 70 | 2.5 | Lot B | 25 | 1 | 0.9995 |
| 8 | −+−+−+ | 68 | 2.7 | Lot B | 22 | 1.1 | 0.999 |
| 9 | +−+−−+ | 72 | 2.3 | Lot A | 22 | 1.1 | 0.9992 |
| 10 | ++++++ | 72 | 2.7 | Lot B | 28 | 1.1 | 0.9995 |
| 11 | 000+00 | 70 | 2.5 | Lot B | 25 | 1 | 0.9996 |
| 12 | 000+00 | 70 | 2.5 | Lot B | 25 | 1 | 0.9995 |

TABLE 15B

| | | | End | | | | |
|---|---|---|---|---|---|---|---|
| | Check | | Check | End | S2, | S3, | D1, |
| | Standard | Check | Standard | Check | LA883 | LA730 | LA510 |
| | Result | Standard | Result | Standard | Result | Result | Result |
| Run | (% PS80) | tailing | (% PS80) | tailing | (% PS80) | (% PS80) | (% PS80) |
| 1 | 0.03 | 1.388 | 0.031 | 1.402 | 0.05 | 0.019 | 0.023 |
| 2 | 0.03 | 1.423 | 0.03 | 1.32 | 0.051 | 0.019 | 0.015 |
| 3 | 0.03 | 1.388 | 0.031 | 1.402 | 0.05 | 0.019 | 0.023 |
| 4 | 0.03 | 1.423 | 0.03 | 1.32 | 0.051 | 0.019 | 0.015 |
| 5 | 0.031 | 1.460 | 0.03 | 1.303 | 0.052 | 0.019 | 0.018 |
| 6 | 0.03 | 1.432 | 0.03 | 1.334 | 0.051 | 0.019 | 0.016 |
| 7 | 0.03 | 1.345 | 0.031 | 1.386 | 0.051 | 0.019 | 0.021 |
| 8 | 0.03 | 1.356 | 0.029 | 1.162 | 0.05 | 0.017 | 0.016 |
| 9 | 0.03 | 1.334 | 0.03 | 1.426 | 0.051 | 0.018 | 0.019 |
| 10 | 0.03 | 1.373 | 0.03 | 1.378 | 0.051 | 0.02 | 0.021 |
| 11 | 0.03 | 1.432 | 0.03 | 1.334 | 0.051 | 0.019 | 0.016 |
| 12 | 0.03 | 1.345 | 0.031 | 1.386 | 0.051 | 0.019 | 0.021 |

Data for the S3 sample indicated that column temperature may have a statistically significant impact on the method at the 0.05 level. No other method parameter showed statistical significance at the 0.05 level.

To assess whether column temperature exhibited a practical impact on the method, overall standard deviation of the 12 runs for the S3 sample was compared to the validation acceptance criterion for the intermediate precision standard deviation of other studies. The standard deviation of 12 runs for sample S3 was 0.0008 and the validation acceptance criterion for intermediate precision standard deviation was SD≤0.007. Therefore, the analysis indicated that overall standard deviation for the S3 sample is less than the validation acceptance criterion. Therefore, column temperature does not exhibit a practical impact on the method.

### Example 4

To confirm that the method was applicable with different detectors, the method of the disclosure was applied using two different models from two different manufactures.

Fractional factorial design of 12 runs was applied utilizing an Alltech 3300 evaporative light-scattering detector. A second study with three runs was applied utilizing an Agilent 1260 evaporative light-scattering detector.

Comparable results were identified with both models of evaporative light-scattering detector. Table 16 demonstrates comparable results for S1, S2, and S3. The calculated result for S1 and S2 was higher than expected, but within the acceptance criterion.

TABLE 16

| | | | | | S1, | S2, | S3, |
|---|---|---|---|---|---|---|---|
| | | | Heating | Gas | LA883 | LA883 | LA730 |
| | | Nebulizer | Tube | Flow | Result | Result | Result |
| | Run | (°C) | (°C) | (L/min) | (% PS80) | (% PS80) | (% PS80) |
| Agilent | 1 | 47 | 90 | 1.7 | 0.0571 | 0.0567 | 0.0211 |
| 1260 | 2 | 45 | 80 | 1.5 | 0.0580 | 0.0580 | 0.0216 |
| | 3 | 43 | 70 | 1.3 | 0.0588 | 0.0583 | 0.0223 |
| Alltech | Average from Runs 1-12 | | | | 0.0591 | 0.0596 | 0.0218 |
| 3300 | | | | | | | |

Therefore, the method of the disclosure is robust across different makes and models of evaporative light-scattering detector.

The method of the disclosure is robust with respect to nebulizer temperature, gas flow rate, column lot, column temperature, and flow rate.

All robustness runs met the method system suitability criteria and acceptable data was generated for each run.

Tailing results for polysorbate 80 on the Alltech 3300 ranged from 1.16 to 1.46.

Moreover, the method of the disclosure demonstrated consistent performance at determining polysorbate concentrations across multiple antibody molecules.

No practical concern was identified from analysis of the evaluated method parameters, indicating that the method is robust for the range of operations. Assessed operating ranges were as described in Tables 17 and 18.

TABLE 17

| | Parameters | Acceptable Range | |
|---|---|---|---|
| ELSD | Nebulizer Temperature | 68 °C-72 °C | |
| | Gas Flow | 2.3 L/min-2.7 L/min | |
| HPLC | Column Temperature | 22-28 | °C |
| | Flow Rate | 0.9-1.1 | mL/min |

TABLE 18

| | Parameters | Acceptable Range |
|---|---|---|
| ELSD | Nebulizer Temperature | 43 °C-47 °C |
| | Gas Flow | 1.3 L/min-1.7 L/min |
| | Heating Tube | 70 °C-90 °C |

This example demonstrates that the method of Example 1 works with different evaporative light-scattering detectors from different manufacturers under different conditions within the acceptable ranges of Tables 23 and 24.

### Example 5

The robustness of the method for measuring polysorbate levels in drug substance and drug product was assessed to confirm its applicability to samples from different origins.

The method was further assessed with three antibody samples, as set out in Table 19. Two samples, DS (drug substance) and DP (drug product) comprised polysorbate 80, whereas the third sample, TFF, did not comprise polysorbate 80.

TABLE 19

| Sample | Approximate | Polysorbate 80 |
|---|---|---|
| Name | Strength | concentration |
| DS | 240 mg/mL | 0.04% |
| DP | 200 mg/mL | 0.04% |
| TFF | 244 mg/mL | 0% |

The suitability of the method was assessed for each sample by applying multiple aliquots from each sample according to the method of Example 1.

At least one blank was applied after the standards to evaluate carryover.

All results met the method system acceptance criteria of Table 3. A stable baseline was observed over blanks prior to the first standard injection and the blank chromatograms were comparable to FIG. 1. No peak was observed in the blank at a level greater than the lowest standard. Chromatographic non-interference was demonstrated for each sample. No carryover was observed.

The results were as set out in Table 20.

TABLE 20

| | Correlation | Check Solution, % |
|---|---|---|
| Sample ID | Coefficient, R² | Difference from Theory |
| 1 | 0.998 | −3, −4, −4, −2, −2 |
| 2 | 0.999 | −2, −3, −2, −3 |
| 3 | 0.998 | −2, −4, −3, −3 |
| 4 | 0.999 | −2, −2, −2, −3 |
| Method Criteria | ≥0.995 | ±20% |

The criterion for percentage difference from theory for the check standard on day 0 was ±10%.

Specificity was assessed by chromatographic non-interference. It was demonstrated by analyzing blank, local reference standard, and STD 1 according to the method of Example 1.

The blank generated a peak at the retention time of polysorbate 80. However, the calibration curve compensated for said interference. Baseline was consistent.

Any interfering peak rising above baseline from the local reference standard was not greater than the corresponding peak in STD 1.

The acceptance criteria were met. Chromatograms were as depicted in FIGS. 1-3. FIG. 1 depicts the blank, FIG. 2 depicts the local reference standard, and FIG. 3 depicts STD1.

### Example 6

The precision and repeatability of the method of Example 1 was determined by preparing six replicate samples of drug substance and six replicate samples of drug product.

Acceptance criteria required the percentage relative standard deviation for 6 repeats to not be more than 10.

Mean percentage relative standard deviation for the drug substance was 0, as shown in Table 21.

TABLE 21

| Preparation | Polysorbate 80 (%) |
|---|---|
| 1 | 0.041737 |
| 2 | 0.042123 |
| 3 | 0.042082 |
| 4 | 0.042215 |
| 5 | 0.042223 |
| 6 | 0.041821 |
| Mean (n = 6) | 0.0420335 |
| Percentage relative | 0 |
| standard deviation (n = 6) | |

Mean percentage relative standard deviation for the drug product was 1, as shown in Table 22.

TABLE 22

| Preparation | Polysorbate 80 (%) |
|---|---|
| 1 | 0.041847 |
| 2 | 0.041181 |
| 3 | 0.041416 |
| 4 | 0.041415 |
| 5 | 0.041116 |
| 6 | 0.041187 |
| Mean (n = 6) | 0.041367667 |
| Percentage relative | 1 |
| standard deviation (n = 6) | |

This example demonstrates that the method of Example 1 was repeatable with a percentage relative standard deviation not more than 10 for both drug substance and drug product. Representative chromatograms for the drug substance and drug product were as depicted in FIGS. 4a and 4b, respectively.

### Example 7

Standard solution stability was assessed to identify the time after which new concentration standards should be produced.

Duplicate calibration curves were prepared on Day 0. One set of standards was stored at ambient conditions and the other set of standards was stored at refrigerated conditions (5 °C±3 °C). “Ambient conditions” constituted room temperature.

Drug product sample was analyzed with calibration curves generated from both sets of standards and with freshly prepared standards on Days 1, 2, and 3.

The acceptance criterion was no more than 20% difference in the sample results, calculated from the fresh standards and aged standards for the aged standards to be recognized as stable.

All standards remained stable for the 3 days of testing. Results were as depicted in Table 23.

TABLE 23

| | | | Percentage |
|---|---|---|---|
| | | Polysorbate | Difference |
| | Interval | 80 (%) in | from Fresh |
| Condition | (Day) | Sample | solutions |
| Fresh Standard | 1 | 0.042328 | NA |
| Solutions | 2 | 0.041603 | NA |
| | 3 | 0.041653 | NA |
| Ambient | 1 | 0.043307 | 2 |
| | 2 | 0.043851 | 5 |
| | 3 | 0.044372 | 7 |
| Refrigerated | 1 | 0.043132 | 2 |
| | 2 | 0.043221 | 4 |
| | 3 | 0.042916 | 3 |

Percentage difference was calculated according to the following equation:

$$\% Difference from Day 0 Result = 100 \times ( \frac{A - B}{B} )$$

wherein A=Sample result from aged curve, and B=Sample result from fresh curve.

### Example 8

To assess the specificity of the method of the disclosure and to confirm that the method's robustness is consistent across multiple molecules, different antibody molecules were evaluated.

Different antibody molecules exist in different matrixes. The matrix compositions from the antibody molecules are described in Table 24. The polysorbate in each was polysorbate 80.

TABLE 24

| Sample | Matrix |
|---|---|
| 5 | 10 mM citrate buffer at pH 5.5-5.7, 15 mM sodium |
| | chloride, and 0.02% PS-80, mg per mL antibody 1 |
| 6 | 10 mM citrate buffer at pH 6.0, 0.02% polysorbate-80, |
| | approximately 5 mg antibody 2 per mL |
| 7 | 10 mM histidine buffer pH 5.5, 150 mM NaCl, 0.06% Tween |
| | 80, 30.35 mg antibody 3 per mL |
| 8 | 10 mM citrate buffer at pH 6.5, 150 mM NaCl, 0.02% |
| | polysorbate 80, 10.1 mg antibody 4 per mL |
| 9 | 10 mM citrate buffer at pH 5.0, 30 mM NaCl, 0.02% PS80, |
| | 10.1 mg antibody 5 per mL |
| 10 | 10 mM citrate buffer at pH 6.5, 0.02% Tween 80, 5.1 mg |
| | antibody 6 per mL |
| 11 | 10 mM sodium citrate buffer at pH 6.0, 150 mM sodium |
| | chloride, 0.02% Polysorbate 80, 5.5 mg antibody 7 per mL |
| 12 | 5 mM histidine buffer at pH 6.0, 0.02% PS80, 10.5 mg |
| | antibody 8 per mL |
| 13 | 10 mM sodium citrate buffer at pH 6.5, 18 mM Sodium |
| | Chloride, 0.04% PS-80, 10.2 mg antibody 9 per mL |
| 14 | 10 mM histidine buffer at pH 6.0, 15 mM NaCl, 0.02% |
| | PS-80, 5.5 mg antibody 10 per mL |
| S2 | DS sample, Lot API 1, ~150 mg /mL, 10 mM histidine |
| | buffer at pH 6.0, 50 mM NaCl, 6% Sucrose, 0.05% PS80 |
| S3 | API: Lot API 2, ~67 mg /mL, 5 mM histidine buffer at |
| | pH 6.0, 150 mM NaCl, 0.02% PS80 |
| D1 | DS stressed sample. This stressed sample is prepared by putting |
| | Demo 4 DS lot API 3 at 40 C for 5 months. It has ~150 mg /mL, |
| | 10 mM histidine buffer at pH 6.0, 140 mM NaCl, 0.04% PS80 |

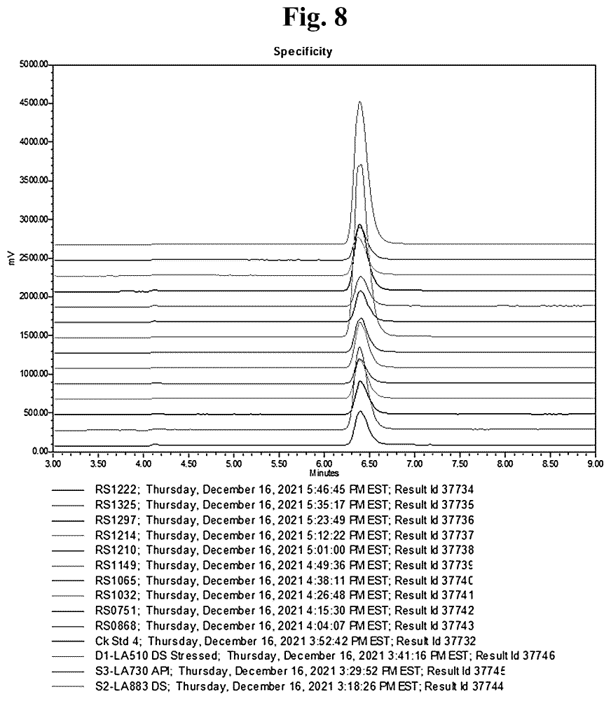

Performing the method demonstrated that the specificity for polysorbate 80 was achieved across all antibody molecules tested. Evaporative light-scattering detection identified a single peak signal at about 6.5 minutes for all samples (FIG. 8). No significant matrix affects were observed. Therefore, the method of the disclosure is suitable for determining polysorbate 80 concentrations in different samples.

### Example 9

To demonstrate the robustness of the method of Example 1 on different polysorbates and by different labs, a further study was conducted.

The method of the example was applied on samples comprising polysorbate 20 (Table 25) or polysorbate 80 (Table 26) by two different labs.

TABLE 25

| | |
|---|---|
| Lab 1 | Lab 2 |

| | Sample | S4 | Sample | S4 |
|---|---|---|---|---|
| Run | 12 result | result | 12 result | result |
| 1 | 0.019 | 0.025 | 0.019 | 0.022 |
| 2 | 0.018 | 0.019 | 0.018 | 0.022 |
| 3 | 0.018 | 0.02 | 0.018 | 0.022 |
| Average | 0.018 | 0.021 | 0.018 | 0.022 |

TABLE 26

| | |
|---|---|
| Lab 1 | Lab 2 |

| | S1 | S2 | S3 | S1 | S2 | S3 |
|---|---|---|---|---|---|---|
| Run | result | result | result | result | result | result |
| 1 | 0.06 | 0.061 | 0.025 | 0.057 | 0.057 | 0.021 |
| 2 | 0.057 | 0.059 | 0.021 | 0.058 | 0.058 | 0.022 |
| 3 | 0.058 | 0.059 | 0.022 | 0.059 | 0.058 | 0.023 |
| Average | 0.058 | 0.060 | 0.023 | 0.058 | 0.058 | 0.022 |

The study demonstrated that the method of the disclosure is robust for different polysorbates and robust results are achieved by the method at different labs.

A further robustness study for polysorbate 20 identified percentage relative standard deviations of less than 10 for two samples (Table 27).

TABLE 27

| | Parameters | | | | | Results | |
|---|---|---|---|---|---|---|---|
| | Nebulizer | | | Column | | Sample | |
| | Temper- | Gas | Column | Temperature | Flow | 12 | S4 |
| Run | ature | Flow | Lot | (°C) | Rate | result | result |
| 1 | 70 | 2.5 | Lot A | 25 | 1 | 0.019 | 0.025 |
| 2 | 72 | 2.7 | Lot A | 22 | 0.9 | 0.018 | 0.019 |
| 3 | 68 | 2.3 | Lot B | 22 | 0.9 | 0.018 | 0.020 |
| 4 | 68 | 2.7 | Lot A | 28 | 0.9 | 0.018 | 0.020 |
| 5 | 70 | 2.5 | Lot A | 25 | 1 | 0.019 | 0.021 |
| 6 | 68 | 2.3 | Lot A | 28 | 1.1 | 0.019 | 0.019 |
| 7 | 72 | 2.3 | Lot B | 28 | 0.9 | 0.018 | 0.021 |
| 8 | 70 | 2.5 | Lot B | 25 | 1 | 0.019 | 0.020 |
| 9 | 68 | 2.7 | Lot B | 22 | 1.1 | 0.018 | 0.019 |
| 10 | 72 | 2.3 | Lot A | 22 | 1.1 | 0.018 | 0.019 |
| 11 | 72 | 2.7 | Lot B | 28 | 1.1 | 0.020 | 0.020 |
| 12 | 70 | 2.5 | Lot B | 25 | 1 | 0.018 | 0.018 |
| | | | | Average | | 0.019 | 0.020 |
| | | | | RSD | | 0.00 | 0.00 |
| | | | | % RSD | | 3.64 | 8.87 |

Two further studies identified acceptable robustness through percentage relative standard deviations for three samples comprising polysorbate 80 (Table 28 and Table 29).

TABLE 28

| | Parameters | | | | | | | |
|---|---|---|---|---|---|---|---|---|
| | | | | Column | | Results | | |
| | Nebulizer | Gas | Column | Temperature | Flow | S1 | S2 | S3 |
| Run | Temperature | Flow | Lot | (°C) | Rate | result | result | result |
| 1 | 70 | 2.5 | Lot A | 25 | 1 | 0.060 | 0.061 | 0.025 |
| 2 | 72 | 2.7 | Lot A | 22 | 0.9 | 0.057 | 0.059 | 0.021 |
| 3 | 68 | 2.3 | Lot B | 22 | 0.9 | 0.058 | 0.059 | 0.022 |
| 4 | 68 | 2.7 | Lot A | 28 | 0.9 | 0.058 | 0.059 | 0.020 |
| 5 | 70 | 2.5 | Lot A | 25 | 1 | 0.058 | 0.059 | 0.022 |
| 6 | 68 | 2.3 | Lot A | 28 | 1.1 | 0.061 | 0.061 | 0.022 |
| 7 | 72 | 2.3 | Lot B | 28 | 0.9 | 0.059 | 0.059 | 0.024 |
| 8 | 70 | 2.5 | Lot B | 25 | 1 | 0.060 | 0.059 | 0.021 |
| 9 | 68 | 2.7 | Lot B | 22 | 1.1 | 0.059 | 0.058 | 0.021 |
| 10 | 72 | 2.3 | Lot A | 22 | 1.1 | 0.060 | 0.061 | 0.021 |
| 11 | 72 | 2.7 | Lot B | 28 | 1.1 | 0.060 | 0.060 | 0.021 |
| 12 | 70 | 2.5 | Lot B | 25 | 1 | 0.059 | 0.060 | 0.021 |
| | | | | Average | | 0.0591 | 0.0596 | 0.0218 |
| | | | | RSD | | 0.00 | 0.00 | 0.00 |
| | | | | % RSD | | 1.97 | 1.67 | 6.74 |

Sample S1 in Table 28 was a stressed sample. The method of the disclosure is also robust on stressed samples.

TABLE 29

| | Parameters | | | | | | | |
|---|---|---|---|---|---|---|---|---|
| | | | | Column | | Results | | |
| | Nebulizer | Gas | Column | Temperature | Flow | S2 | S3 | D1 |
| Run | Temperature | Flow | Lot | (°C) | Rate | result | result | result |
| 1 | 70 | 2.5 | Lot A | 25 | 1 | 0.050 | 0.019 | 0.023 |
| 2 | 72 | 2.7 | Lot A | 22 | 0.9 | 0.050 | 0.018 | 0.021 |
| 3 | 68 | 2.3 | Lot B | 22 | 0.9 | 0.049 | 0.018 | 0.020 |
| 4 | 68 | 2.7 | Lot A | 28 | 0.9 | 0.051 | 0.018 | 0.021 |
| 5 | 70 | 2.5 | Lot A | 25 | 1 | 0.051 | 0.019 | 0.015 |
| 6 | 68 | 2.3 | Lot A | 28 | 1.1 | 0.052 | 0.019 | 0.018 |
| 7 | 72 | 2.3 | Lot B | 28 | 0.9 | 0.050 | 0.019 | 0.017 |
| 8 | 70 | 2.5 | Lot B | 25 | 1 | 0.051 | 0.019 | 0.016 |
| 9 | 68 | 2.7 | Lot B | 22 | 1.1 | 0.050 | 0.017 | 0.016 |
| 10 | 72 | 2.3 | Lot A | 22 | 1.1 | 0.051 | 0.018 | 0.019 |
| 11 | 72 | 2.7 | Lot B | 28 | 1.1 | 0.051 | 0.020 | 0.021 |
| 12 | 70 | 2.5 | Lot B | 25 | 1 | 0.051 | 0.019 | 0.021 |
| | | | | Average | | 0.0506 | 0.0186 | 0.0190 |
| | | | | RSD | | 0.00 | 0.00 | 0.00 |
| | | | | % RSD | | 1.57 | 4.27 | 13.47 |

D1 was a super stressed sample maintained at 40 °C for 5 months. The sample showed high viscosity.

Therefore, the method of the disclosure is robust for different polysorbates.

### EQUIVALENTS

Those skilled in the art will recognize many equivalents to the specific embodiments of the disclosure escribed herein. The scope of the present disclosure is not intended to be limited to the above Description, but rather is as set forth in the claims.

1. A method for measuring polysorbate levels in a sample, the method comprising:
applying an aliquot of the sample onto a high-performance liquid chromatography system with a mixed-mode column;
eluting the sample with a gradient from a first mobile phase to a second mobile phase; and
applying evaporative light-scattering detection to the eluant after exiting the column, thereby measuring polysorbate levels;
wherein the first mobile phase comprises: 0-20% of an acid; 1-70% of an organic solvent selected from acetonitrile, methanol, tetrahydrofuran, isopropyl alcohol, or mixtures thereof; and water; and
wherein the second mobile phase comprises: 0-20% of an acid; 80-100% of an organic solvent selected from acetonitrile, methanol, tetrahydrofuran, isopropyl alcohol, or mixtures thereof; and optionally water.

2. The method according to claim 1, wherein the acid in the first mobile phase and/or the second mobile phase is a volatile acid.

3. The method according to claim 2, wherein the volatile acid is formic acid.

4. The method according to any one of the preceding claims, wherein the first mobile phase and/or the second mobile phase comprises 0-2% acid.

5. The method according to any one of the preceding claims, wherein the organic solvent in the first mobile phase is different from the organic solvent in the second mobile phase.

6. The method according to any one of the preceding claims, wherein the first mobile phase comprises 2% formic acid, 20% acetonitrile, and 78% purified water.

7. The method according to any one of the preceding claims, wherein the second mobile phase comprises 2% formic acid and 98% isopropyl alcohol.

8. The method according to any one of the preceding claims, wherein the measured polysorbate comprises polysorbate 20, polysorbate 40, polysorbate 60, and/or polysorbate 80.

9. The method according to any one of the preceding claims, wherein the measured polysorbate comprises polysorbate 20 and/or polysorbate 80.

10. The method according to any one of the preceding claims, wherein the measured polysorbate comprises polysorbate 20.

11. The method according to any one of the preceding claims, wherein the measured polysorbate comprises polysorbate 80.

12. The method according to any one of the preceding claims, further comprising, before applying the aliquot to be measured to the column:
applying a blank onto a high-performance liquid chromatography system with a mixed-mode column;
eluting the blank with a gradient from a first mobile phase to a second mobile phase; and
applying evaporative light-scattering detection to the blank after exiting the column;
wherein the first mobile phase comprises: 0-20% of an acid; 1-70% of an organic solvent selected from acetonitrile, methanol, tetrahydrofuran, isopropyl alcohol, or mixtures thereof; and water; and
wherein the second mobile phase comprises: 0-20% of an acid; 80-100% of an organic solvent selected from acetonitrile, methanol, tetrahydrofuran, isopropyl alcohol, or mixtures thereof; and optionally water.

13. The method according to claim 12, wherein applying evaporative light-scattering detection to the blank produces a baseline signal.

14. The method according to claim 12 or claim 13, further comprising, after the first blank has been applied to the column and before applying the aliquot to be measured to the column:
applying a second blank onto a high-performance liquid chromatography system with a mixed-mode column;
eluting the blank with a gradient from a first mobile phase to a second mobile phase; and
applying evaporative light-scattering detection to the blank after exiting the column;
wherein the first mobile phase comprises: 0-20% of an acid; 1-70% of an organic solvent selected from acetonitrile, methanol, tetrahydrofuran, isopropyl alcohol, or mixtures thereof; and water; and
wherein the second mobile phase comprises: 0-20% of an acid; 80-100% of an organic solvent selected from acetonitrile, methanol, tetrahydrofuran, isopropyl alcohol, or mixtures thereof; and optionally water;
wherein applying evaporative light-scattering detection to the second blank produces a stable baseline signal.

15. The method according to any one of the preceding claims, wherein the first mobile phase and/or the second mobile phase was prepared within 2 weeks of performing the method.

16. The method according to any one of the preceding claims, further comprising quantifying the measured level of polysorbate in the sample.

17. The method according to claim 16, wherein quantifying the measured level of polysorbate in the sample comprises comparing the measured amount of polysorbate against a calibration curve.

18. The method according to claim 17, wherein comparing the measured amount of polysorbate against the calibration curve identifies a quantity of polysorbate in the aliquot.

19. The method according to claim 17 or claim 18, wherein the calibration curve is generated by:
separately applying one or more concentration standards comprising known amounts of polysorbate onto a high-performance liquid chromatography system with a mixed-mode column;
eluting the concentration standards with a gradient from a first mobile phase to a second mobile phase; and
applying evaporative light-scattering detection to the concentration standards after each exits the column, thereby measuring polysorbate levels; and
generating a calibration curve from the measured levels of polysorbate in the concentration standards;
wherein the first mobile phase comprises: 0-20% of an acid; 1-70% of an organic solvent selected from acetonitrile, methanol, tetrahydrofuran, isopropyl alcohol, or mixtures thereof; and water; and
wherein the second mobile phase comprises: 0-20% of an acid; 80-100% of an organic solvent selected from acetonitrile, methanol, tetrahydrofuran, isopropyl alcohol, or mixtures thereof; and optionally water.

20. The method according to claim 19, wherein one or more of the concentration standards produces a larger signal than the aliquot and one or more of the concentration standards produces a smaller signal than the aliquot.

21. The method according to claim 19 or claim 20, wherein the amount of polysorbate in the two or more concentration standards does not exceed the maximum detectable signal for evaporative light-scattering detection.

22. The method according to any one of claims 19-21, wherein the amount of polysorbate in the concentration standard comprising the largest amount of polysorbate has a peak height of about 80% of the maximum detectable signal.

23. The method according to any one of claims 19-22, wherein applying evaporative light-scattering detection to a blank produces a signal that is lower than a signal produced by the concentration standard comprising the smallest amount of polysorbate.

24. The method according to any one of claims 19-23, wherein the calibration curve is generated using three or more, four or more, five or more, or six or more concentration standards.

25. The method according to any one of claims 17-24, wherein the calibration curve is prepared gravimetrically.

26. The method according to any one of claims 17-25, wherein the calibration curve has a coefficient of determination (R²) greater than or equal to 0.995.

27. The method according to claim 26, wherein the coefficient of determination is greater than or equal to 0.998.

28. The method according to any one of claims 17-27, wherein the calibration curve is prepared using a quadratic fit through zero.

29. The method according to any one of the preceding claims, wherein the percentage relative standard deviation of two or more aliquots of the sample is 10 or less.

30. The method according to any one of the preceding claims, wherein the gradient comprises:
100% first mobile phase and 0% second mobile phase from 0.0 minutes to 2.0 minutes;
85% first mobile phase and 15% second mobile phase from 2.1 minutes to 5.0 minutes;
30% first mobile phase and 70% second mobile phase from 5.1 minutes to 7.6 minutes;
0% first mobile phase and 100% second mobile phase from 7.7 minutes to 9.0 minutes; and/or
100% first mobile phase and 0% second mobile phase from 9.1 minutes to 10.0 minutes.

31. The method according to any one of the preceding claims, wherein the sample is applied onto the mixed-mode column at a temperature of 22-28 °C.

32. The method according to any one of the preceding claims, wherein the eluant is eluted from the column with a flow rate of 0.9-1.1 mL/min.

33. The method according to any one of the preceding claims, wherein the evaporative light-scattering detection utilizes an Alltech 3300 detector.

34. The method according to claim 33, wherein the method is performed using a nebulizer temperature of the detector of 68-72 °C.

35. The method according to claim 33 or claim 34, wherein the method is performed using a gas flow rate of the detector of 2.3-2.7 L/min.

36. The method according to any one of claims 1-32, wherein the evaporative light-scattering detection utilizes an Agilent 1260 evaporative light-scattering detector.

37. The method according to claim 36, wherein the method is performed using a nebulizer temperature of the detector of 43-47 °C.

38. The method according to claim 36 or claim 37, wherein method is performed using a heating tube temperature of the detector of 70-90 °C.

39. The method according to any one of claims 36-38, wherein the method is performed using a gas flow of the detector of 1.3-1.7 L/min.

40. The method according to any one of the preceding claims, wherein the sample is a drug substance.

41. The method according to any one of claims 1-39, wherein the sample is a drug product.

42. A method for quantifying polysorbate levels in a sample, the method comprising:
applying a first polysorbate concentration standard onto a high-performance liquid chromatography system with a mixed-mode column, eluting the sample with a gradient from a first mobile phase to a second mobile phase, and applying evaporative light-scattering detection to the eluant after exiting the column, thereby measuring polysorbate levels;
applying one or more further polysorbate concentration standards comprising different known amounts of polysorbate compared to the first concentration standard onto a high-performance liquid chromatography system with a reversed-mixed-mode column, eluting the sample with a gradient from a first mobile phase to a second mobile phase, and applying evaporative light-scattering detection to the eluant after exiting the column, thereby measuring polysorbate levels;
generating a calibration curve from the measured polysorbate levels in the polysorbate concentration standards;
applying an aliquot of the sample onto a high-performance liquid chromatography system with a mixed-mode column, eluting the sample with a gradient from a first mobile phase to a second mobile phase; and applying evaporative light-scattering detection to the eluant after exiting the column, thereby measuring polysorbate levels; and
quantifying the amount of polysorbate in the aliquot of the sample by comparison against the calibration curve;
wherein the first mobile phase comprises 2% formic acid, 20% acetonitrile, and 78% purified water and the second mobile phase comprises 2% formic acid and 98% isopropyl alcohol.

43. The method of claim 40, wherein the method is practiced according to any one of claim 8-15 or 20-41.
